(19) United States
(12) Patent Application Publication
(10) Pub. No.: US 2026/0179640 A1
(43) Pub. Date: Jun. 25, 2026

(54) GENERATING AN ENHANCED AUDIO SIGNAL USING JOINTLY TRAINED MODELS

(71) Applicant: Meta Platforms Technologies, LLC, Menlo Park, CA (US)

(72) Inventors: Ashutosh Pandey, Shoreline, WA (US); Juan Azcarreta Ortiz, Cambridge (GB); Ali Aroudi, Kirkland, WA (US); Buye Xu, Sammamish, WA (US); Cagdas Bilen, Cambridge (GB); Jacob Ryan Donley, Issaquah, WA (US); Sanha Lee, Cambridge (GB); Ke Li, Post Falls, ID (US); Daniel Davis Eugene Wong, Bellevue, WA (US)

(21) Appl. No.: 19/423,779

(22) Filed: Dec. 17, 2025

Related U.S. Application Data
(60) Provisional application No. 63/737,415, filed on Dec. 20, 2024.

(51) Int. Cl. G10L 21/0232; G10L 21/0208; G10L 21/0216; G10L 21/0224; G10L 21/0264; H04S 3/00

(52) U.S. Cl. CPC G10L 21/0232; G10L 21/0224; G10L 21/0264; H04S 3/008; G10L 2021/02082; G10L 2021/02166; H04S 2400/01; H04S 2400/15

(57) ABSTRACT

A computer-implemented method is disclosed in which a first machine-learning model is used to generate an intermediate estimate of a target signal within input audio. Based on this estimate and the input audio, parameters of an adaptive filter are computed. The adaptive filter is then applied to the input audio to produce a filtered audio signal. A second machine-learning model generates an enhanced audio signal based at least in part on the filtered signal, with both models jointly trained end-to-end to enhance the target signal. Various other aspects are also disclosed.

### CROSS REFERENCE TO RELATED APPLICATION

This application claims the benefit of U.S. Provisional Application No. 63/737,415, filed 20 Dec. 2024, the disclosures of each of which are incorporated, in their entirety, by this reference.

### SUMMARY

A method is provided for generating an enhanced audio signal using two machine-learning models trained together. The process begins by using a first machine-learning model to generate an intermediate estimate of a target signal within input audio. Based on this estimate and the input audio, parameters of an adaptive filter are computed. The adaptive filter is then applied to the input audio to produce a filtered audio signal. A second machine-learning model, trained jointly with the first, generates an enhanced audio signal using at least the filtered signal as input.

A system is described that includes at least one physical processor and physical memory with computer-executable instructions. When executed, these instructions cause the processor to generate an intermediate estimate of a target signal within input audio using a first machine-learning model. The processor then computes parameters of an adaptive filter based on the estimate and the input audio, applies the adaptive filter to the input audio to produce a filtered audio signal, and generates an enhanced audio signal using a second machine-learning model trained together with the first, based at least in part on the filtered signal.

A non-transitory computer-readable medium is provided with computer-executable instructions that, when executed by at least one physical processor of a computing device, cause the device to generate an intermediate estimate of a target signal within input audio using a first machine-learning model. The device then computes parameters of an adaptive filter based on the estimate and the input audio, applies the adaptive filter to the input audio to produce a filtered audio signal, and generates an enhanced audio signal using a second machine-learning model trained together with the first, based at least in part on the filtered signal.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic of a multichannel speech enhancement system processing audio signals from a microphone array to produce improved target speech according to some embodiments of this disclosure.

FIG. 2 is a block diagram of an architecture for multichannel speech enhancement, integrating beamforming and machine learning-based refinement according to some embodiments of this disclosure.

FIG. 3 is a block diagram of a low-compute neural front end processing pipeline for transforming an input audio signal into an enhanced audio signal according to some embodiments of this disclosure.

FIG. 4 is a block diagram of a speech enhancement system utilizing spatial and temporal processing blocks to generate an improved reference microphonerophone STFT according to some embodiments of this disclosure.

FIG. 5 is a schematic of interconnected neural network modules arranged for frequency-dependent spatial processing according to some embodiments of this disclosure.

FIG. 6 is a block diagram of frequency-dependent spatial processing modules arranged per STFT bin for multichannel-to-monaural feature mapping according to some embodiments of this disclosure.

FIG. 7 is a block diagram of neural network layers showcasing input, hidden layers, and representation rearrangement for efficient temporal processing according to some embodiments of this disclosure.

FIG. 8 is a block diagram of a low-compute neural front end system for multichannel speech enhancement, integrating spatial and temporal processing with MCWF refinement according to some embodiments of this disclosure.

FIG. 9 is a block diagram of a speech enhancement system utilizing spatial processing, temporal modeling, and complex spectral masking according to some embodiments of this disclosure.

FIG. 10 is a schematic of a low-compute neural front end architecture for multichannel speech enhancement, showcasing spatial and temporal processing blocks integrated with complex spectral masking according to some embodiments of this disclosure.

FIG. 11 is a schematic of a two-stage system for multichannel speech enhancement integrating deep neural network-based spectral masking and MCWF processing according to some embodiments of this disclosure.

FIG. 12 is a flow diagram of an exemplary method for generating an enhanced audio signal using jointly trained models.

FIG. 13 is an illustration of an example artificial-reality system according to some embodiments of this disclosure.

FIG. 14 is an illustration of an example artificial-reality system with a handheld device according to some embodiments of this disclosure.

FIG. 15A is an illustration of example user interactions within an artificial-reality system according to some embodiments of this disclosure.

FIG. 15B is an illustration of example user interactions within an artificial-reality system according to some embodiments of this disclosure.

FIG. 16A is an illustration of example user interactions within an artificial-reality system according to some embodiments of this disclosure.

FIG. 16B is an illustration of example user interactions within an artificial-reality system according to some embodiments of this disclosure.

FIG. 17 is an illustration of an example wrist-wearable device of an artificial-reality system according to some embodiments of this disclosure.

FIG. 18 is an illustration of an example wearable artificial-reality system according to some embodiments of this disclosure.

FIG. 19 is an illustration of an example augmented-reality system according to some embodiments of this disclosure.

FIG. 20A is an illustration of an example virtual-reality system according to some embodiments of this disclosure.

FIG. 20B is an illustration of another perspective of the virtual-reality systems shown in FIG. 20A.

FIG. 21 is a block diagram showing system components of example artificial- and virtual-reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Multichannel speech enhancement for edge devices, such as smart glasses and wearable technologies, has traditionally relied on a combination of beamforming and monaural machine learning-based speech enhancement. These conventional approaches are typically limited to enhancing only the magnitude of speech signals, leaving the phase component unaltered. As a result, the overall clarity and intelligibility of the processed speech are constrained, and the full capabilities of deep learning remain underutilized. Additionally, many existing solutions require substantial computational and memory resources, making them impractical for real-time, on-device processing where latency and power consumption are significant factors. The separation of beamforming and speech enhancement into distinct processes further introduces inefficiencies and limits the effectiveness of these systems, particularly in dynamic and noisy acoustic environments.

The subject matter described herein provides a streamlined, ultra-low compute framework for multichannel speech enhancement that leverages complex spectral masking to jointly enhance both the magnitude and phase components of speech signals. This framework integrates beamforming and speech enhancement into a unified machine learning model, thereby optimizing the use of deep learning for audio processing. The architecture employs a dual-stage approach, wherein a first deep neural network estimates parameters for a multichannel filter, and a second neural network refines the output to further improve speech quality. Specialized algorithms, including frequency-dependent spatial processing blocks and compute-optimized gated recurrent unit layers, are utilized to efficiently process multichannel audio data while maintaining computational demands suitable for real-time operation on resource-constrained devices. The described approach delivers speech enhancement performance across a wide field of view, adapts dynamically to changing acoustic scenes, and achieves significant improvements in both efficiency and audio quality compared to conventional methods.

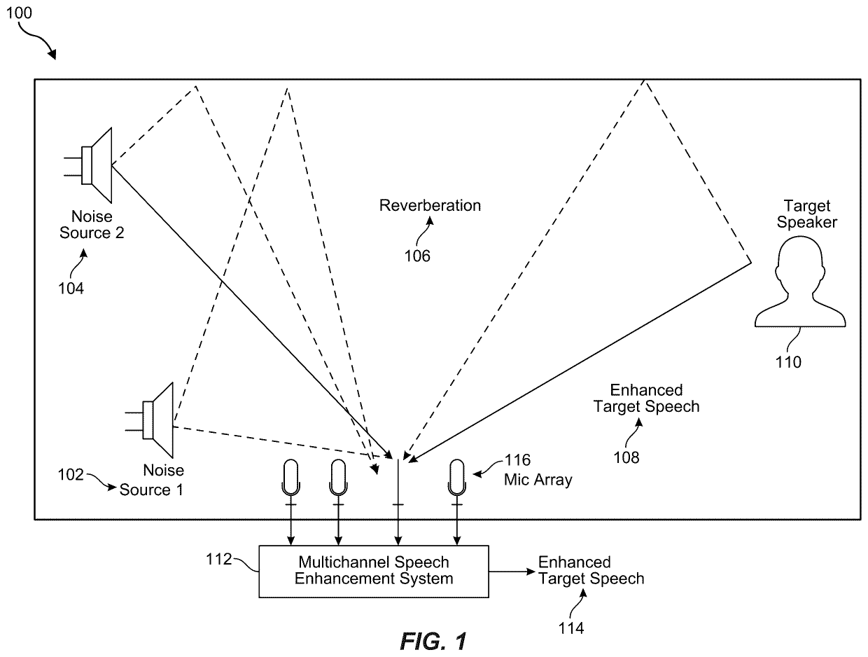

FIG. 1 illustrates an acoustic environment in which a target speaker 110 produces desired speech while one or more noise sources 102 and 104 generate interfering sounds. Reverberation 106 arises from reflections within the room. A microphone array 116 captures the resulting mixture at multiple spatially separated sensors. A multichannel speech enhancement system 112 receives the array signals and produces enhanced target speech 108 by suppressing non-target components and mitigating reverberation while preserving the target speaker's content. As shown by the dashed propagation paths from the target and noise sources to the array, the system leverages spatial diversity to exploit differences in direction of arrival and multipath structure. The output enhanced target speech 108 represents a cleaner, intelligible signal suitable for downstream applications on resource-constrained devices such as smart glasses and wearables.

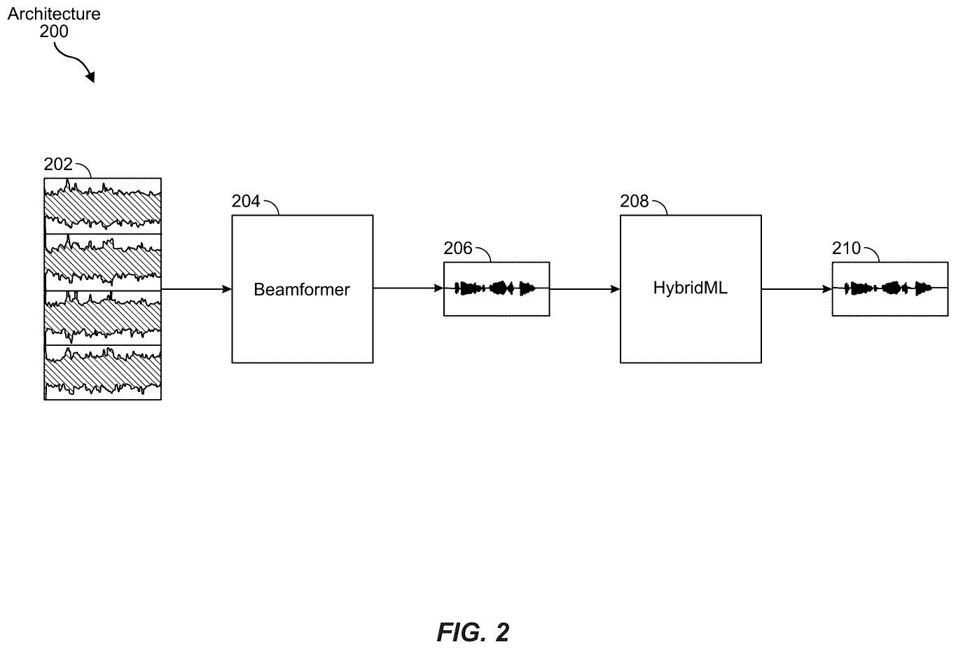

FIG. 2 depicts an architecture 200 in which multichannel noisy spectrum 202 (e.g., a short-time Fourier transform representation of the array signals) is first processed by a beamformer 204 to form a reference microphone noisy spectrum 206. A learned postfilter module, learned postfilter 208, further refines the reference spectrum to produce a reference microphone enhanced spectrum 210. This arrangement exemplifies the conversational focus framework in which linear spatial processing is used to exploit rich multichannel information, followed by a low-compute monaural machine-learning model that suppresses residual noise. The framework simplifies design for edge deployment by combining traditional beamforming with a compact neural network tuned for magnitude spectrum enhancement and residual artifact removal.

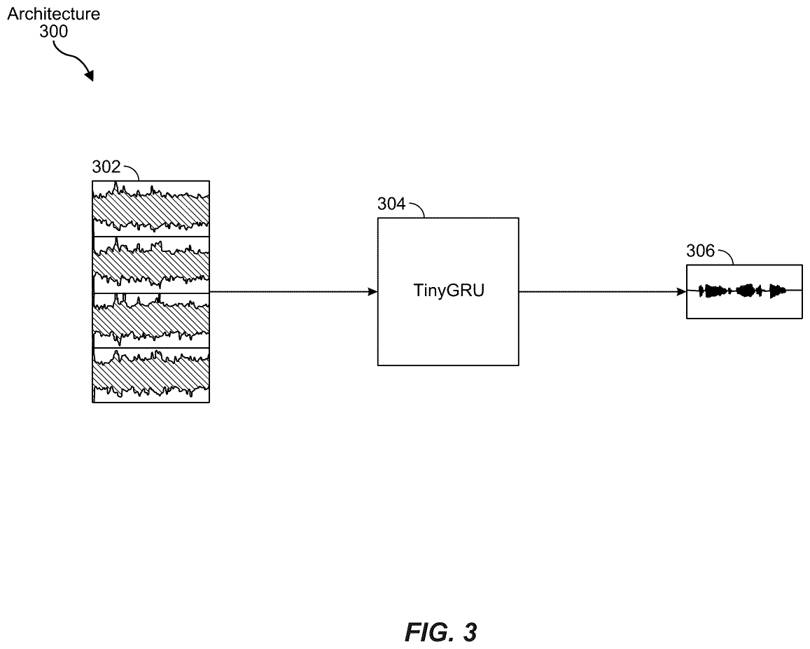

FIG. 3 shows an alternative signal path 300 in which an input audio signal 302 is processed entirely by a low-compute neural front end 304 to produce an enhanced audio signal 306. The front end outputs the real and imaginary components of a complex mask to jointly refine magnitude and phase under low latency. The spatial stage employs frequency-dependent trainable filters implemented as per-frequency multiple-input-multiple-output mappings, and the temporal stage uses split recurrent layers to provide compute-efficient causal modeling. Per-bin features are progressively compressed to a monaural stream suitable for downstream recurrent processing.

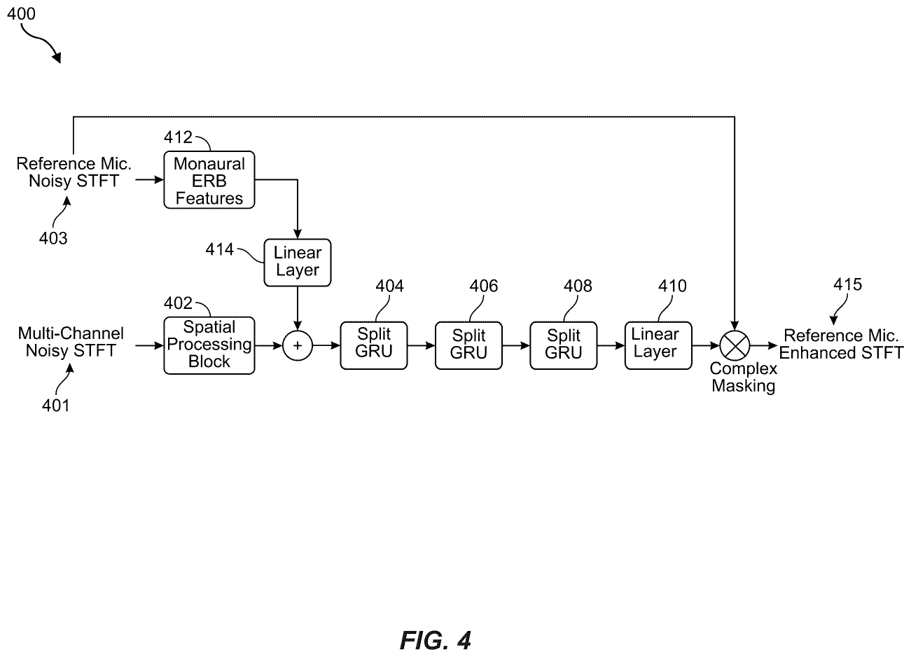

FIG. 4 presents a detailed block diagram 400 of the low-compute neural front end processing pipeline operating in the time-frequency domain. A multi-channel noisy STFT 401 is provided to a spatial processing block 402 having frequency-dependent trainable spatial filters. At each frequency bin, the block applies small fully connected transformations to the concatenated real and imaginary parts of the multichannel spectrum to generate a monaural spatially informed feature. In parallel, a reference microphone noisy STFT 403 is transformed into monaural ERB (Equivalent Rectangular Bandwidth) features 412 that downsample and aggregate high-frequency content for compute efficiency and robustness; a linear layer 414 maps the ERB features into the model's feature space. The spatial features and mapped ERB features are fused (e.g., by summation) and passed through a sequence of Split GRU blocks 404, 406, 408 that provide efficient temporal processing under causality constraints.

In split recurrent layers, the feature vector is divided across the feature dimension into R segments, each processed by a parallel GRU; outputs are rearranged such that each GRU's output contributes to all GRUs in the subsequent layer, yielding a wider effective network at reduced compute. A terminal linear layer 410 projects the recurrent output to a complex mask representation interpreted as the real and imaginary components of a mask applied to the reference microphone noisy STFT. In one compute-reduced complex masking variant, the enhanced reference spectrum is formed by separately multiplying real and imaginary parts: \hat{ }S r= [symbol] (Y r)· [symbol] (M)+j [symbol] (Y r)· [symbol] (M), jointly refining magnitude and phase while conserving operations compared to standard complex multiplication. The result is a reference microphone enhanced STFT 415, which can be converted to time-domain audio or used downstream (e.g., to derive an adaptive multichannel filter). Descriptions of the low-compute neural front end presented herein emphasize this front end's design principles: (i) leveraging multichannel spatial cues via frequency-dependent trainable filters; (ii) employing split recurrent layers for low-compute causal temporal modeling; (iii) transitioning from magnitude-only enhancement to complex spectrum enhancement by outputting real and imaginary mask components; and (iv) incorporating ERB features to reduce compute while preserving perceptually salient information. These components collectively enable a streamlined, low-compute pipeline that exploits spectro-temporal and spatial information to produce enhanced audio suitable for real-time edge deployment. The temporal modeling employs split recurrent layers that partition features into parallel recurrent units under causality constraints. This front end leverages frequency dependent trainable spatial filters, split recurrent layers for low compute causal temporal modeling, complex masking with real and imaginary mask components, and ERB features for efficiency and robustness.”

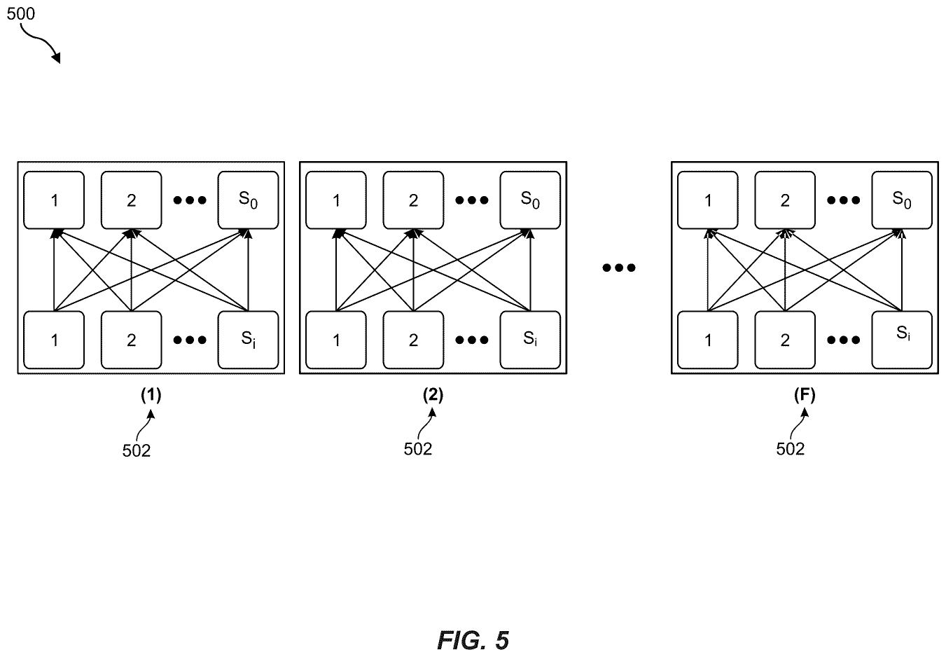

FIG. 5 illustrates frequency-dependent spatial processing modules arranged per STFT bin to provide compute-efficient multichannel to monaural feature mapping. For each frequency bin, a tiny fully-connected neural network, shown as 500(1), 500(2) . . . 500(F), receives as input the concatenated real and imaginary parts of the multichannel spectrum and outputs a compressed spatial feature. The per-frequency design mimics a filter-and-sum beamformer at each bin while remaining lightweight. Hidden layers progressively reduce the spatial channel dimension (e.g., 8→4→2→1), and each layer employs a PReLU nonlinearity to maintain expressiveness with low compute. Stacking “spatial filtering+nonlinearity” per bin allows the model to exploit spatial cues without large convolutional kernels or heavy matrix operations. This block may be expressly designed to utilize spatial information and provide useful representation to GRU layers, enabling the downstream recurrent temporal model to operate on a compact, spatially informed monaural stream.

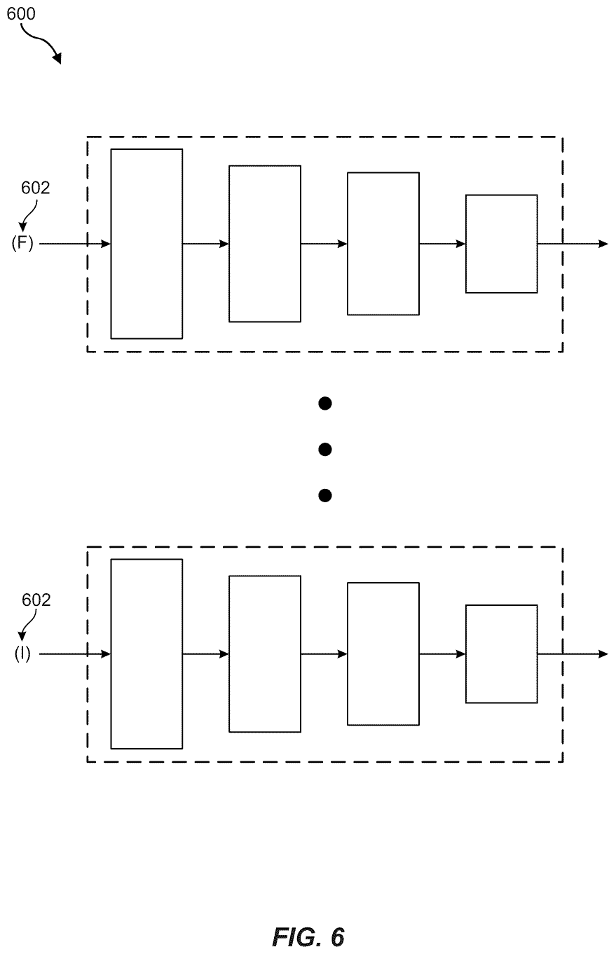

FIG. 6 depicts the layered structure of the per-frequency spatial processing blocks, labeled 602(1) . . . 602(F), highlighting progressive compression and frame-level normalization that yields a scale-agnostic model. Within each dashed block, multiple small layers are stacked, each feeding the next with decreasing width, implementing the frequency-dependent trainable spatial filters. After the first spatial layer, a frame-based normalization removes the mean and variance over channel and frequency dimensions (e.g., over a feature map), which together with the chosen masking approach, renders the model scale-agnostic. In parallel to the spatial path, ERB features from the reference microphone are computed (downsampling and aggregating high-frequency content for efficiency) and mapped through a linear layer; these ERB features provide perceptually salient monaural cues that are fused with the spatial output. The result is a compute-efficient spatial front end that captures inter-channel relationships per frequency while stabilizing scale and preparing features for causal temporal modeling.

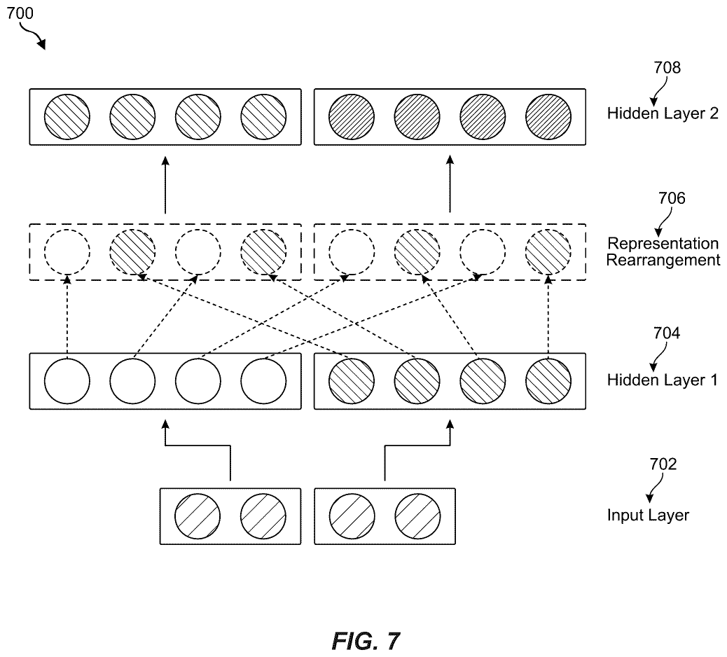

FIG. 7 details the split recurrent layers temporal processing with representation rearrangement between layers. An input layer 702 feeds a first hidden layer 704, after which a “representation rearrangement” 706 mixes outputs across splits before a second hidden layer 708. In split recurrent layers, the feature vector is divided across the feature dimension into R segments; each segment is processed by a parallel GRU, reducing computational load while widening the effective network. Causality is maintained by updating GRU states frame-by-frame. The rearrangement step ensures that the output of each GRU in one layer contributes to all GRUs in the subsequent layer, increasing cross-segment interaction without incurring the compute of a single large GRU. This architecture enables parallel GRUs to reduce the computational load and provides a wider network with lower compute, delivering efficient temporal modeling that is well suited to low-latency, real-time enhancement. Together, the per-frequency spatial blocks of FIG. 5-6 and the Split recurrent layers of FIG. 7 implement the low-compute neural front end described herein: frequency-dependent trainable spatial filters stacked with nonlinearities, frame-based normalization for scale-agnostic behavior, ERB feature fusion for robustness and efficiency, and parallel recurrent processing to capture temporal dynamics with minimal compute. These modules implement the spatial and temporal components of the low-compute neural front end described with reference to FIG. 4

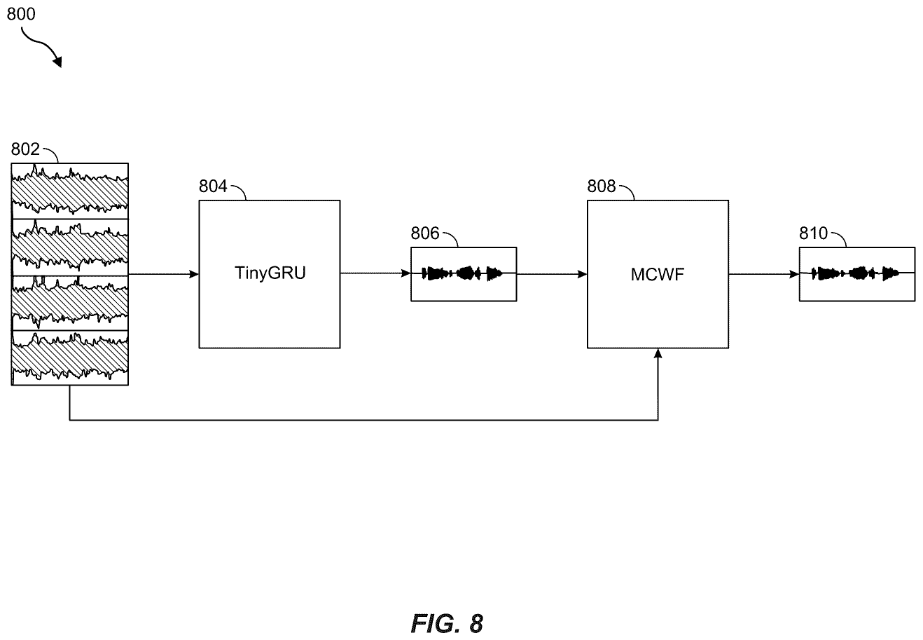

FIG. 8 depicts a block diagram of a low-compute neural front end-based multichannel speech enhancement pipeline. At the input, a multichannel noisy spectrum 802 represents a time-frequency transform (e.g., an STFT) of audio captured across multiple microphones. This multichannel spectral tensor is forwarded into a low-compute neural front end module 804 that performs low-compute, learned enhancement using frequency-dependent spatial filtering followed by causal recurrent processing. Low-compute neural front end produces a reference microphone enhanced spectrum 806, which is a monaural, spatially informed output aligned to a chosen reference channel. The enhanced reference spectrum 806, together with the original multichannel noisy spectrum 802, is provided to an MCWF module 808. The MCWF (multichannel Wiener filter) computes an adaptive spatial filter whose parameters are derived from recursive statistics of the multichannel input and the low-compute neural front end reference output, thereby reducing nonlinear artifacts while preserving target speech. The MCWF outputs an enhanced output spectrum 810 that exhibits improved suppression of interference and reverberation with better naturalness relative to a purely neural output. The diagram emphasizes the joint use of a compact neural front end for complex spectral masking and a classical multichannel statistical filter for artifact mitigation and spatial suppression, with the original multichannel data feeding the MCWF alongside the low-compute neural front end result.

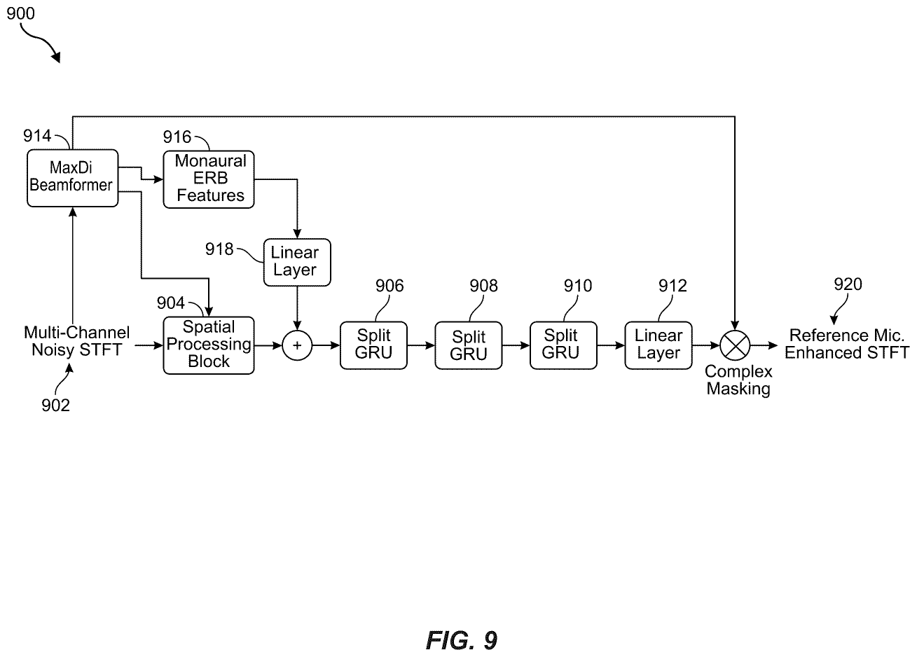

FIG. 9 presents a detailed signal-flow diagram of the low-compute neural front end operating in the time-frequency domain and incorporating auxiliary features and spatial processing. A multi-channel noisy STFT 902 is first processed by a spatial processing block 904 composed of per-frequency trainable multiple-input-multiple-output mappings. For each frequency bin, small fully connected transformations ingest the concatenated real and imaginary parts of all channels to produce a compressed monaural spatial feature that mimics filter-and-sum behavior while remaining compute-efficient.

In parallel, a beamformer 914 forms a reference microphone path used to derive monaural ERB features 916 from the reference channel. The ERB features are passed through a linear layer 918 to map them into the low-compute neural front end feature space. The spatial feature from block 904 and the mapped ERB feature from 918 are fused (e.g., summed), providing a spatially informed, perceptually motivated feature stream.

This fused feature stream is processed by a stack of split GRU blocks 906, 908, 910. In split recurrent layers, the feature vector is partitioned along its feature dimension into R segments, each handled by a parallel GRU to reduce compute while widening the effective network under causal operation. Between layers, representation rearrangement mixes outputs across segments, increasing cross-segment interaction without incurring the cost of a single large GRU.

A terminal linear layer 912 projects the recurrent output to complex mask parameters that act on the reference microphone noisy STFT to produce a reference microphone enhanced STFT 920 via complex masking. The architecture therefore integrates frequency-dependent spatial filtering, ERB-based perceptual features, and low-compute causal temporal modeling to generate a refined monaural reference spectrum. That spectrum can be converted to time-domain audio or supplied downstream (e.g., to an adaptive multichannel filter) for further enhancement.

### EXAMPLE

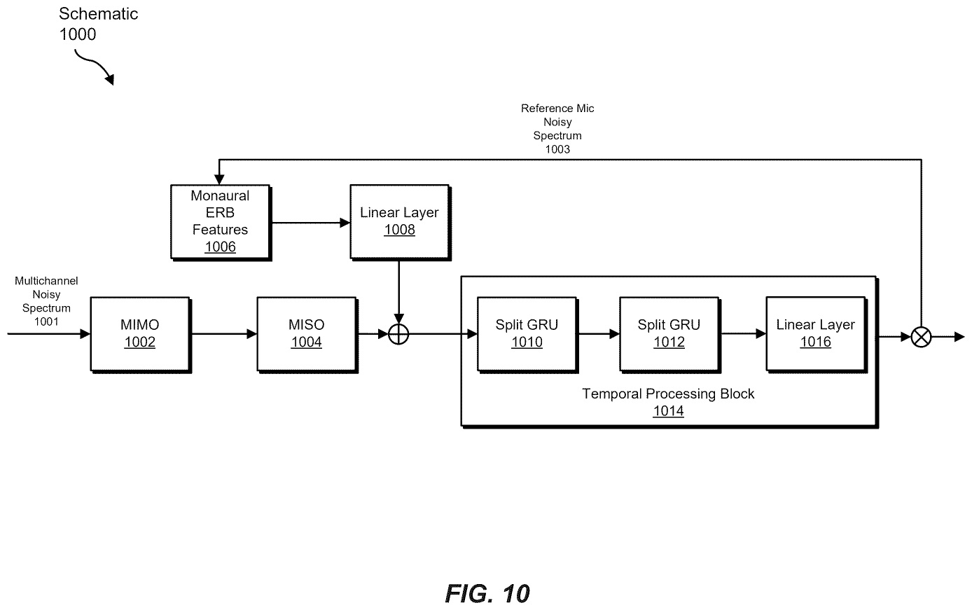

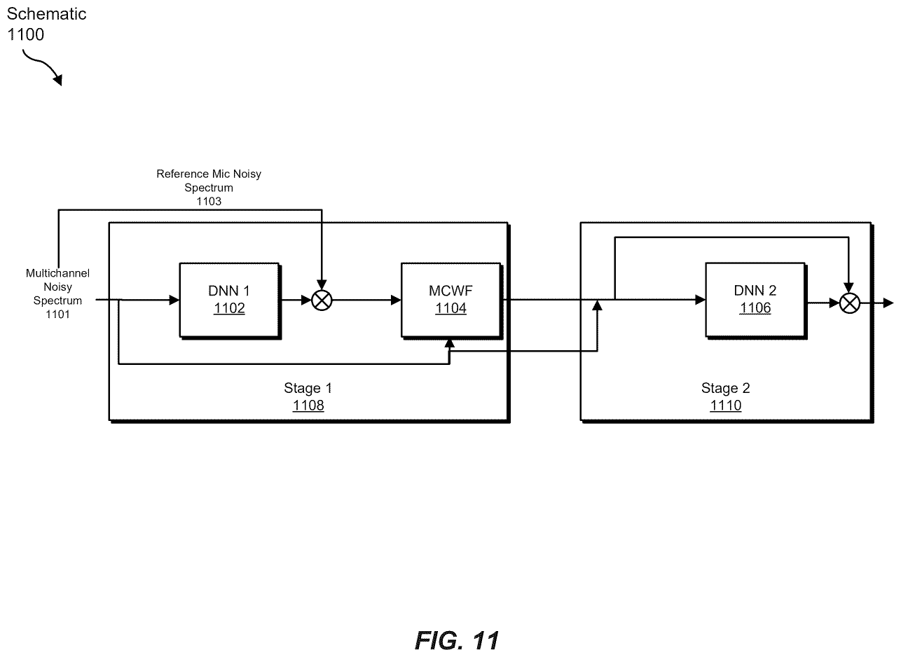

FIGS. 10 and 11 align with the front-end and multi-stage framework previously described. FIG. 10 corresponds to the compact, low-compute neural front end that ingests a multichannel noisy spectrum, performs frequency-dependent spatial processing followed by split recurrent temporal modeling, and projects to a complex mask applied to a reference-microphone spectrum to yield a reference-microphone enhanced spectrum. FIG. 11 depicts the full two-stage pipeline in which that front end (DNN 1) conditions an adaptive multichannel Wiener filter whose parameters are estimated online from the multichannel input and the front-end output, and a subsequent neural post-processor (DNN 2) applies complex spectral masking to the beamformed signal, delivering the final enhanced audio under joint, end-to-end training.

FIG. 10 illustrates a low-compute neural front end-based multichannel speech enhancement pipeline. Multichannel noisy spectrum 1001 serves as the input to the system and is generated by transforming audio captured by a microphone array into a time-frequency domain representation using a Short-Time Fourier Transform (STFT). Multichannel noisy spectrum 1001 contains both real and imaginary components for each frequency bin and channel, providing the raw data required for subsequent spatial and temporal processing.

MIMO (Multi-Input, Multiple Output) 1002 receives multichannel noisy spectrum 1001 and applies frequency-dependent spatial filters implemented as trainable convolution layers. MIMO 1002 concatenates real and imaginary parts of the spectrum to form a real-valued multichannel signal and applies parametric ReLU nonlinearities. MIMO 1002 outputs a spatially compressed representation that captures inter-channel relationships and prepares the data for further processing.

Reference mic noisy spectrum 1003 is derived from multichannel noisy spectrum 1001 and represents the spectral data corresponding to a designated reference microphone in microphone array 116. Reference mic noisy spectrum 1003 is used to compute monaural features and serves as a baseline for enhancing the audio signal.

MISO (Multiple Input, Single Output) 1004 processes the spatially compressed output from MIMO 1002. MISO 1004 applies additional frequency-dependent transformations to refine spatial features and produce a monaural spatially informed feature stream. MISO 1004 reduces the dimensionality of the multichannel data, transitioning from multiple input channels to a single output channel while preserving spatial information. The output of MISO 1004 is combined with features derived from reference mic noisy spectrum 1003.

Monaural ERB features 1006 are computed from reference mic noisy spectrum 1003 using an Equivalent Rectangular Bandwidth filter bank or other suitable filter(s). Monaural ERB features 1006 aggregate high-frequency content into perceptually salient features, downsampling the spectral data for computational efficiency. Monaural ERB features 1006 are mapped into the model's feature space via linear layer 1008 and fused with the spatially informed output from MISO 1004. Linear layer 1008 maps monaural ERB features 1006 into the feature space of low-compute neural front end. Linear layer 1008 applies a learned linear transformation to monaural ERB features 1006, facilitating their integration into the temporal processing pipeline.

Split GRU 1010 is the first layer in temporal processing block 1014 and processes the fused feature stream from linear layer 1008 and MISO 1004. Split GRU 1010 divides the input feature vector into multiple segments along the feature dimension, with each segment processed by a parallel GRU. The outputs of split GRU 1010 are rearranged to ensure cross-segment interaction in subsequent layers.

Split GRU 1012 is the second layer in temporal processing block 1014 and builds upon the output of split GRU 1010. Split GRU 1012 processes feature segments in parallel using GRUs, adhering to causality constraints. Representation rearrangement between layers ensures that each GRU's output contributes to all GRUs in the subsequent layer. Temporal processing block 1014 encompasses split GRU layers 1010 and 1012, as well as linear layer 1016. Temporal processing block 1014 performs efficient temporal modeling under causality constraints, leveraging the parallel processing capabilities of split GRU layers. Linear layer 1016 projects the output of temporal processing block 1014 into a complex mask representation. This mask includes real and imaginary components, which are applied to reference mic noisy spectrum 1003 to jointly refine the magnitude and phase of the audio signal. Final output 1021 is the enhanced audio signal produced by low-compute neural front end. Final output 1021 is obtained by applying the complex mask generated by linear layer 1016 to reference mic noisy spectrum 1003, resulting in an audio signal with refined magnitude and phase components.

Consider a microphone array with C channels recording an audio mixture composed of a desired reverberant talker speech S∈ [symbol] ^{C×N}, corrupted by background noise N∈ [symbol] ^{C×N}. In the time-domain, the observed multichannel mixture signal Y∈ [symbol] ^{C×N} can be expressed as:

$$Y = S + N \qquad ( 1 )$$

As shown in FIG. 10, multichannel noisy spectrum 1001 represents the short-time Fourier transform of the mixture captured by the microphone array and serves as the input to the low-compute neural front end. The primary goal of multichannel speech enhancement is to produce a reliable estimation, ŝᵣ∈ [symbol] ^{N}, of the target talker speech sᵣ∈ [symbol] ^{N} at a specific reference microphone r, given the observed noisy recording Y.

The multichannel noisy input, Y, is transformed into the time-frequency domain via the Short-Time Fourier Transform (STFT), resulting in Y∈ [symbol] ^{C×T×F}, where T is the number of frames and F is the number of frequency bins. Additionally, the model applies an ERB filter bank to the noisy reference channel, effectively downsampling the input features by aggregating high-frequency bands.

Referring to FIG. 10, multichannel noisy spectrum 1001 is provided to a frequency-dependent spatial processing stage, where MIMO 1002 applies per-frequency multiple-input-multiple-output mappings to the concatenated real and imaginary parts. In parallel, reference mic noisy spectrum 1003 is derived for a designated reference channel and used to compute monaural ERB features 1006 that are mapped by linear layer 1008 into the model's feature space for subsequent fusion.

In FIG. 10, MIMO 1002 and MISO 1004 together implement the spatial processing block using per-frequency trainable matrices that mimic filter-and-sum behavior while remaining compute-efficient. Inspired by traditional signal processing techniques, this spatial convolution mimics a frequency domain Filter-And-Sum beamformer operation, albeit implemented in the real domain. Each spatial convolution layer l comprises F distinct matrices, each of size

$${C}_{out}^{l} \times {C}_{in}^{l} ,$$

which are multiplied by the input tensor of

$${C}_{in}^{l}$$

channels at each frequency bin. This process yields an output tensor with

$${C}_{out}^{l}$$

spatial dimension and F frequency bins. At the input, the real and imaginary part of the STFT are concatenated to form a real-valued multichannel signal with 2·C channels. Each convolution is followed by parametric ReLU nonlinearity. MISO 1004 produces a monaural, spatially informed feature stream that is fused with the mapped ERB features from linear layer 1008.

The final layer of the spatial processing block outputs a single channel signal. This monaural output is combined with the output derived from transforming the ERB features of the reference microphone input using a linear layer. With reference to FIG. 10, the fused features are forwarded into temporal processing block 1014 that contains split GRU 1010 and split GRU 1012.

Temporal processing block 1014 comprises split GRU 1010 followed by split GRU 1012, each operating causally and performing representation rearrangement between layers to widen effective capacity at reduced compute. GRU units adhere to causality constraints by iteratively updating their state based on the current input frame and previous state values.

The Split recurrent layers layer enhances efficiency by dividing the input into R segments across the feature dimension and processing each segment with one of R parallel GRUs. The outputs of each layer are reorganized such that the output from a specific GRU is distributed to all GRUs in the subsequent layer [24]. Employing a split factor of R effectively reduces computational demands by a factor of R. The final output of the GRU model is then projected to a size of 2F using a linear layer, which is subsequently split into real and imaginary components to form a complex mask. A terminal linear layer 1016 projects the recurrent output to complex mask parameters.

As shown in FIG. 10, linear layer 1016 outputs real and imaginary mask components that act on the reference mic noisy spectrum 1003 to form final output 1021, a reference microphone enhanced spectrum aligned to the chosen channel. Assuming the model generates a mask M∈ [symbol] ^{T×F}, the enhanced signal Ŝᵣ∈ [symbol] ^{T×F} is computed by applying the complex mask to the noisy input signal from the reference microphone r as:

$${\hat{S}}_{r} = ( {Y}_{r} ) \cdot ( M ) + j ( {Y}_{r} ) \cdot ( M ) \qquad ( 2 )$$

The real and imaginary parts of the mask are respectively multiplied by the corresponding parts of the signal. This method, which deviates slightly from the standard complex multiplication approach, requires less computation and achieves similar performance. In FIG. 10, this operation is depicted by applying the complex mask to the reference mic noisy spectrum 1003 to yield final output 1021

Turning to FIG. 11, stage 1 1108 employs DNN 1 1102 (the low-compute neural front end of FIG. 10) to produce the reference microphone enhanced spectrum that conditions MCWF 1104. The MCWF beamformer optimizes a linear filter in the frequency domain to minimize the Mean Square Error (MSE) between the desired signal and the beamformed signal. By using the estimated speech Ŝᵣ as a proxy for the target signal, the beamformer coefficients can be calculated in a closed-form solution as follows:

$$𝔼 [ {YY}^{H} ] ( t , f ) = \frac{1}{t} {\sum }_{i = 1}^{i = t} Y ( i , f ) {Y}^{H} ( i , f ) \qquad ( 3 )$$

$$𝔼 [ Y {\hat{S}}_{r}^{H} ] ( t , f ) = \frac{1}{t} {\sum }_{i = 1}^{i = t} Y ( i , f ) {\hat{S}}_{r}^{H} ( i , f ) \qquad ( 4 )$$

$$W ( t , f ) = 𝔼 [ {YY}^{H} ] {( t , f )}^{- 1} 𝔼 [ Y {\hat{S}}_{r}^{H} ] ( t , f ) \qquad ( 5 )$$

In FIG. 11, multichannel noisy spectrum 1101 and the output of DNN 1 1102 are used to form the auto- and cross-covariance terms consumed by MCWF 1104. The inverse operation in Eq. 5 can be computed in an online manner with O(N\hat{ }2) complexity by running the iterative Sherman-Morrison-Woodbury inversion algorithm.

TABLE I
Performance of the low-compute neural front end in difference
setups. (A)-(D) use different masking appraoches.

| | STOI | PESQ | SNR | MAC | Para. |
|---|---|---|---|---|---|
| Noisy | 61.4 | 1.54 | −1.4 | | |
| (a) Sigmoid | 70.0 | 1.99 | 6.9 | 18 | 138 |
| (b) Softplus | 70.0 | 2.00 | 6.9 | 18 | 138 |
| (c) Complex-1 | 69.6 | 2.01 | 6.9 | 20 | 151 |
| (d) Complex-2 | 70.0 | 2.02 | 6.9 | 20 | 151 |
| (d) wo ERB | 69.3 | 2.00 | 6.7 | 19 | 145 |
| (a) + MCWF | 71.7 | 2.02 | 6.5 | 34 | 138 |
| (b) + MCWF | 72.2 | 2.04 | 6.8 | 34 | 138 |
| (c) + MCWF | 73.9 | 2.08 | 7.1 | 36 | 151 |
| (d) + MCWF | 73.9 | 2.08 | 7.1 | 36 | 151 |
| (c) + MCWF + (c) | 78.9 | 2.38 | 8.7 | 56 | 304 |
| (d) + MCWF + (d) | 78.2 | 2.35 | 8.4 | 56 | 304 |

TABLE II
PERFORMANCE ANALYSIS OF TGRU.

| Typ. | GRUs | Filt. | STOI | PESQ | SNR | MAC | Para. |
|---|---|---|---|---|---|---|---|
| (a) | 1 | (1,) | 71.9 | 2.01 | 6.5 | 25 | 74 |
| | | (4, 1) | 72.4 | 2.03 | 6.6 | 26 | 80 |
| | | (8, 4, 2, 1) | 72.6 | 2.03 | 6.7 | 28 | 94 |
| | 2 | (4, 1) | 73.2 | 2.06 | 6.9 | 30 | 109 |
| | 3 | (4, 1) | 73.8 | 2.07 | 7.1 | 34 | 137 |
| | | (8, 4, 2, 1) | 74.0 | 2.08 | 7.1 | 36 | 151 |
| (b) | 1 | (1,) | 75.2 | 2.21 | 7.7 | 35 | 147 |
| | | (4, 1) | 76.2 | 2.25 | 8.0 | 37 | 162 |
| | | (8, 4, 2, 1) | 76.7 | 2.28 | 8.1 | 41 | 191 |
| | 2 | (4, 1) | 77.7 | 2.32 | 8.4 | 44 | 218 |
| | | (4, 1) | 78.5 | 2.36 | 8.5 | 52 | 275 |
| | 3 | (8, 4, 2, 1) | 78.9 | 2.38 | 8.7 | 56 | 304 |

A) TGRU + MCWF,
B) TGRU + MCWF + TGRU.

The covariance matrices are computed in an online fashion by applying cumulative empirical mean, a reasonable assumption since the target and receiver sources are non-stationary. The adaptive weights computed by MCWF 1104 are applied to the multichannel input, and the enhanced spectrum exits stage 1 1108 for downstream refinement. Finally, the estimated beamformer coefficients W∈ [symbol] ^{N×T×F} are applied to the input multichannel audio:

$${\hat{S}}_{MCWF} = {W}^{H} Y \qquad ( 6 )$$

The output from the MCWF is further refined using a second-stage neural network that includes identical spatial and temporal processing blocks. As depicted in FIG. 11, the beamformed audio from Eq. 6 is concatenated with the multichannel noisy input and processed by a second-stage DNN, which employs complex masking to enhance the initial output. This two-stage arrangement shown in FIG. 11—DNN 1 1102 and MCWF 1104 in stage 1 1108, followed by DNN 2 1106 in stage 2 1110—enables end-to-end training under real-time constraints.

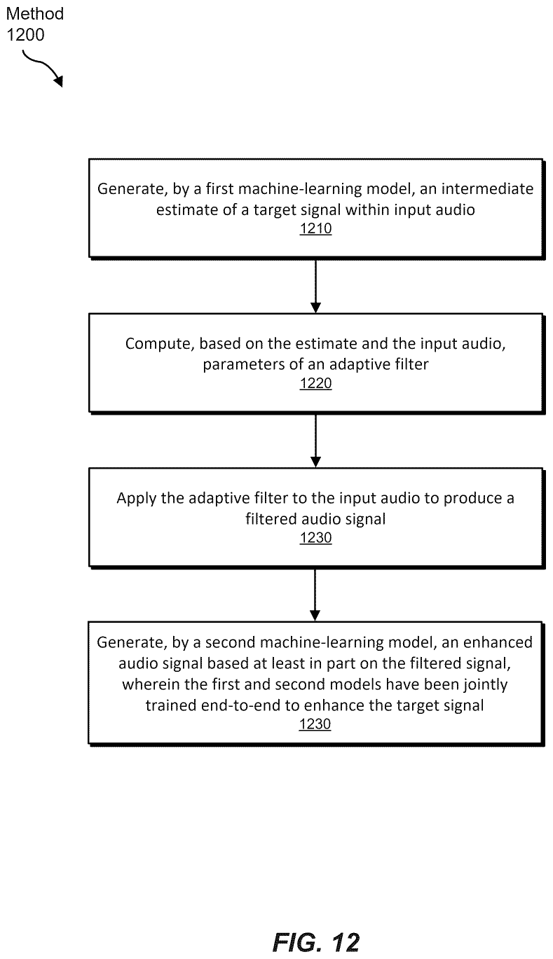

Referring now to FIG. 12, a flow diagram illustrates an example method that operationalizes the foregoing architecture as a sequence of causal, frame-synchronous steps. In some examples, the first stage corresponds to DNN 1 1102 of FIG. 11, implemented as the low-compute neural front end of FIG. 10; the adaptive filtering corresponds to MCWF 1104; and the final stage corresponds to DNN 2 1106. The stages shown correspond to the neural front end that produces an intermediate estimate, the online computation of adaptive filter parameters driven by that estimate and the multichannel input, the application of the adaptive filter to generate a spatially filtered signal, and a jointly trained neural post-processor that performs residual enhancement. For clarity, each block in FIG. 12 aligns with the functional elements described above and can be executed on resource-constrained devices under low-latency constraints.

At step 1210, one or more of the systems describe herein may generate, by a first machine-learning model, an intermediate estimate of a target signal within input audio. This step introduces an initial neural front end that receives the input audio and produces an estimate of the target speech that is sufficiently clean to guide subsequent spatial filtering. In some embodiments the first model operates causally and at low latency so that the estimate is available frame by frame for real-time processing on resource-constrained devices. In one embodiment, the input features include multichannel noisy spectrum 1001 and reference microphone noisy spectrum 1003, and the intermediate estimate is produced by projecting through linear layer 1016 to form complex mask parameters that, when applied to 1003, yield reference microphone enhanced spectrum 1021.

In some examples, the “input audio” may be a single-channel or a multichannel recording captured by a microphone array and represented in the time domain or in a time-frequency domain such as a short-time Fourier transform. The “target signal” refers to the desired speech component at a designated reference microphone or virtual reference, in reverberant and noisy conditions. An “intermediate estimate” is a provisional reconstruction of the target signal that may include residual noise or artifacts but is of sufficient quality to condition later modules. The “first machine-learning model” denotes any trainable function approximator, such as a recurrent, convolutional, or transformer-based network, configured to map input audio features to the intermediate estimate.

This step can be performed in multiple ways. In one approach the first model corresponds to FIG. 10, where linear layer 1016 outputs real and imaginary mask components applied to the reference microphone spectrum 1003 to produce spectrum 1021. In another approach the first model outputs a magnitude-only mask or a spectral gain that is later combined with a phase proxy. In further variants the first model operates purely in the time domain and predicts a waveform estimate; or it fuses multichannel spatial features produced by frequency-dependent trainable spatial filters with monaural features such as ERB bands. Temporal modeling can be realized with gated recurrent units, split recurrent layers, temporal convolutions with causal dilations, or lightweight attention blocks, with optional frame-wise normalization to achieve scale-agnostic behavior.

Examples include an eight-microphone glasses array whose STFT features feed a low-compute neural front end-style front end that produces a complex mask yielding a reference-channel enhanced spectrum, or a two-microphone earable in which a monaural DNN predicts a denoised waveform at 16 kHz. In another example, the model uses ERB features derived from a beamformed reference path and fuses them with per-frequency MIMO spatial features before passing them through two stacked split recurrent layers to form the intermediate estimate under a 16 ms algorithmic latency.

At step 1220, one or more of the systems described herein may compute, based on the estimate and the input audio, parameters of an adaptive filter. This step derives spatial or spectral filter coefficients that adapt to the acoustic scene using statistics of the original input together with the guidance provided by the intermediate estimate. The resulting parameters are updated online to follow changes in interferers, room response, and sensor noise. As shown in FIG. 11, the adaptive filter parameters are formed by MCWF 1104 using recursive auto- and cross-covariance terms computed from multichannel noisy spectrum 1101 and the intermediate estimate (e.g., 1021) output by DNN 1 1102.

In this context, “parameters” refer to coefficients of a linear or nonlinear filter, such as complex weights per frequency and per channel, smoothing factors, or adaptation rates. An “adaptive filter” denotes a filter whose coefficients vary with time and frequency as a function of observed data, for example a multichannel Wiener filter, a minimum-variance distortionless response beamformer, or a neural Wiener filter. The “estimate” is the output of step 1210 and serves as a proxy for the desired signal in cross-covariance calculations or as conditioning input to a parameter-prediction network.

Parameter computation can proceed in different manners. In a closed-form statistical approach, recursive auto- and cross-covariance matrices are updated frame by frame and the filter weights are obtained from matrix equations with efficient inverse updates. In a learned approach, a small network consumes features from the input audio and the intermediate estimate and directly predicts filter taps or adaptation coefficients. Hybrid strategies may blend the two by learning frequency-dependent forgetting factors for the covariance recursion while preserving the analytical solution for the filter weights. The computation can operate per frequency bin in the STFT domain or in subband domains aligned to ERB scales. Examples include computing multichannel Wiener filter weights using cumulative means over past frames, with the cross term formed between the multichannel input and the reference-channel estimate; learning time-varying, frequency-dependent smoothing factors that accelerate adaptation when interferers move; or predicting diagonal loading terms with a tiny auxiliary network to stabilize matrix inversions on wearable devices with quantized arithmetic.

At step 1230 one or more of the systems described here may apply the adaptive filter (e.g., MCWF 1104) to the input audio to produce a filtered audio signal. This step executes the spatial or spectral filtering using the parameters from Step 1220, yielding a signal with reduced interference and reverberation while preserving the target's content. The operation is performed causally and with bounded latency in order to satisfy real-time constraints. In FIG. 11, the filtered (beamformed) spectrum is the output of MCWF 1104 exiting stage 1 1108.

The “filtered audio signal” is the output of the adaptive filter and may be a single-channel signal aligned to a designated reference or a multichannel signal suitable for further processing. “Applying the adaptive filter” encompasses multiplying complex weights with the multichannel spectrum in each time-frequency bin, performing time-domain convolution with time-varying taps, or executing an equivalent linear transformation in a subband domain. The input audio is the same signal described for step 1210, optionally buffered or windowed for overlap-add reconstruction.

There are several ways to perform this step. In one example the system multiplies, at each frequency, the Hermitian transpose of the weight vector with the multichannel STFT vector to form a beamformed spectrum and then performs inverse STFT with overlap-add. In another example, a time-domain FIR filter bank applies per-microphone, time-varying filters and sums the outputs. In a neural Wiener variant, the system computes Wiener-like gains and applies them to subband coefficients. Implementations may include safeguards such as diagonal loading, mask clipping, or soft thresholds to control musical noise and artifacts.

Illustrative scenarios include producing a monaural, natural-sounding beamformed signal for smart glasses during a conversation in a café, where the filter steers toward the target and suppresses diffuse babble; generating a dereverberated talker signal in a living room using online covariance updates as the wearer turns their head; or providing a multichannel filtered output that retains binaural cues for later rendering while significantly reducing interference from off-axis talkers.

At step 1240, one or more of the systems described herein may generate, by a second machine-learning model, an enhanced audio signal based at least in part on the filtered signal, wherein the first and second models have been jointly trained end-to-end to enhance the target signal. This step performs residual enhancement and artifact suppression using a neural post-processor that consumes the filtered signal and optionally auxiliary inputs to deliver the final enhanced output. Joint training encourages co-adaptation of the first model, the adaptive filter, and the second model under a unified objective. As depicted in FIG. 11, this corresponds to DNN 2 1106 operating in stage 2 1110, which refines the MCWF output via complex spectral masking.

The “second machine-learning model” is a trainable module that refines the filter output and may implement complex spectral masking, waveform denoising, or vocoder-style resynthesis. “Enhanced audio signal” denotes the final output intended for playback or downstream modules. “Jointly trained end-to-end” refers to optimization of both neural models and any differentiable filter parameterizations with respect to a composite loss that may include time-domain SNR, spectral magnitude loss, phase consistency, and perceptual proxies.

This step can be realized in several ways. In one embodiment, the second model receives the filtered reference-channel spectrum concatenated with features derived from the original multichannel input and predicts a complex mask to correct residual noise and phase distortions. In another embodiment, a lightweight time-domain network predicts a correction waveform that is added to the filtered signal. Variants may condition the second model on estimated voice activity, direction-of-arrival features, or learned uncertainty maps, and may employ split recurrent layers, causal temporal convolutions, or lightweight attention to meet latency and compute budgets. End-to-end training can unroll the covariance updates or use stop-gradient approximations while still propagating useful gradients to the first model. Examples include training a compact complex-masking postfilter to remove musical noise introduced by aggressive spatial filtering in a crowded restaurant, or a time-domain residual network that restores high-frequency crispness while maintaining low distortion at 8-16 ms latency. In another example, both neural stages are trained together with a composite objective that balances speech reconstruction accuracy, artifact suppression, and perceptual quality, yielding a final enhanced signal that improves PESQ and STOI over either stage alone on an eight-microphone wearable platform.

In some embodiments, the input audio is multichannel audio captured by a microphone array, and the adaptive filter operates as a spatial filter. Leveraging multiple spatially distributed sensors can provide direction-of-arrival and inter-channel coherence cues that distinguish target speech from interferers and reverberation.

In certain examples, a spatial filter exploits these cues by weighting and combining channels to emphasize the spatial signature of the desired source while attenuating off-axis or diffuse noise. Such configurations may enable robust enhancement across dynamic scenes and support downstream low-compute processing.

In some embodiments, the input audio is transformed into a time-frequency representation, and both parameter computation for the adaptive filter and generation of the intermediate estimate occur in that domain. Operating per frame and per frequency bin can allow localized modeling of speech and noise characteristics that vary over time and frequency. In certain examples, time-frequency processing supports causal operation with bounded latency and aligns naturally with complex masking and multichannel covariance estimation. This approach may enable efficient implementation on edge devices through compact per-bin computations and overlap-add reconstruction.

In some embodiments, the adaptive filter is a multichannel Wiener filter whose parameters are computed online from recursive estimates of auto- and cross-covariance matrices of the input audio and the intermediate estimate. Using the estimate as a proxy target can enable formation of cross terms that steer the filter toward the desired speech. In certain examples, online recursion provides continuous adaptation to non-stationary scenes, tracking changes in interferers, room response, and sensor noise. This may yield improved suppression with controlled distortion compared to static designs, while remaining amenable to low-compute updates.

In some embodiments, the second machine-learning model applies complex spectral masking to jointly refine magnitude and phase of the filtered signal to produce the enhanced audio. Predicting real and imaginary mask components can correct phase errors that magnitude-only methods cannot address.

In certain examples, joint magnitude-phase refinement reduces musical noise and residual artifacts left by spatial filtering, improving intelligibility and naturalness. Operating on the filtered signal may allow the post-processor to focus compute on residuals rather than full separation.

In some embodiments, the first machine-learning model includes a frequency-dependent spatial block composed processing of per-frequency multiple-input-multiple-output convolutions, followed by a recurrent temporal processing block. Per-bin mappings can compress multichannel complex spectra into monaural, spatially informed features.

In certain examples, these compact features preserve directional cues while reducing channel dimensionality for downstream temporal modeling. The subsequent recurrent block may capture speech dynamics under causality constraints, enabling low-latency enhancement.

In some embodiments, the recurrent temporal processing block comprises split gated recurrent unit layers configured to process feature segments in parallel while maintaining causality. Partitioning the feature vector into splits can allow multiple smaller GRUs to operate concurrently.

In certain examples, inter-layer representation rearrangement mixes outputs across splits, approximating a wider network at reduced compute. This design may achieve effective temporal capacity with minimal memory and energy, suitable for real-time edge deployment.

In some embodiments, the first and second machine-learning models are trained end-to-end using a composite objective that includes one or more of target reconstruction loss, phase consistency loss, perceptual quality loss, and artifact suppression loss. A unified objective can align front-end estimation, adaptive filtering, and post-processing. In certain examples, co-optimization balances fidelity with perceptual quality, discouraging over-suppression and nonlinear artifacts. Incorporating phase-aware and perceptual terms may guide the models to produce natural-sounding speech with improved intelligibility under resource constraints.

In view of the foregoing, the disclosed systems and methods provide a concrete, engineering-driven solution to the technical problem of real-time speech enhancement on resource-constrained multichannel devices operating in non-stationary acoustic scenes. By jointly training a low-compute front-end that performs frequency-dependent spatial feature extraction and causal temporal modeling, an analytically grounded adaptive spatial filter with online covariance updates, and a post-processor that applies complex spectral masking to refine magnitude and phase, the invention overcomes the limitations of magnitude-only enhancement, decoupled beamforming pipelines, and latency- or compute-prohibitive models. The architecture's per-bin processing, split recurrent layer parallelism, scale-agnostic normalization, and end-to-end objectives yield measurable improvements in intelligibility and quality at sub-50 MMAC/s budgets while maintaining causal operation. These concrete algorithmic and structural choices translate directly into reduced computational load, bounded memory footprint, stable adaptation, and improved artifact control, thereby advancing the state of the art in on-device multichannel speech enhancement and providing a technical effect commensurate with the technical features recited herein.

Features from any of the embodiments described herein may be used in combination with one another in accordance with the general principles described herein. These and other embodiments, features, and advantages will be more fully understood upon reading the following detailed description in conjunction with the accompanying drawings and claims.

### EXAMPLE EMBODIMENTS

[Inventor(s): The Following Section is a Restatement of the Claims for Legal Purposes. Feel Free to Skip Over this Section and Focus Your Review on the Claims]
Clause 1. A computer-implemented method comprising: generating, by a first machine-learning model, an intermediate estimate of a target signal within input audio; computing, based on the estimate and the input audio, parameters of an adaptive filter; applying the adaptive filter to the input audio to produce a filtered audio signal; generating, by a second machine-learning model, an enhanced audio signal based at least in part on the filtered signal, wherein the first and second models have been jointly trained end-to-end to enhance the target signal.
Clause 2. The method of clause 1, wherein the input audio comprises multichannel audio captured by a microphone array and the adaptive filter comprises a spatial filter.
Clause 3. The method of clause 1, further comprising transforming the input audio into a time-frequency representation, wherein computing the parameters of the adaptive filter and generating the intermediate estimate are performed in a time-frequency domain.
Clause 4. The method of clause 1, wherein the adaptive filter comprises a multichannel Wiener filter and the parameters are computed online using recursive estimates of cross- and auto-covariance matrices of the input audio and the intermediate estimate.
Clause 5. The method of clause 1, wherein the second machine-learning model applies complex spectral masking to jointly refine magnitude and phase of the filtered audio signal to produce the enhanced audio signal.
Clause 6. The method of clause 1, wherein the first machine-learning model includes a frequency-dependent spatial processing block comprising per-frequency multiple-input-multiple-output convolutions followed by a recurrent temporal processing block.
Clause 7. The method of clause 6, wherein the recurrent temporal processing block comprises split gated recurrent unit layers configured to process feature segments in parallel under causality constraints.
Clause 8. The method of clause 1, wherein the first and second machine-learning models are jointly trained end-to-end using a composite objective comprising at least one of target reconstruction loss, phase consistency loss, perceptual quality loss, and artifact suppression loss.
Clause 9. A system comprising: at least one physical processor; and physical memory comprising computer-executable instructions that, when executed by the at least one physical processor, cause the at least one physical processor to: generate, by a first machine-learning model, an intermediate estimate of a target signal within input audio; compute, based on the estimate and the input audio, parameters of an adaptive filter; apply the adaptive filter to the input audio to produce a filtered audio signal; and generate, by a second machine-learning model, an enhanced audio signal based at least in part on the filtered signal, wherein the first and second models have been jointly trained end-to-end to enhance the target signal.
Clause 10. The system of clause 9, wherein the input audio comprises multichannel audio captured by a microphone array and the adaptive filter comprises a spatial filter.
Clause 11. The system of clause 9, wherein the computer-executable instructions further cause the at least physical processor to transform the input audio into a time-frequency representation, wherein the computer-executable instructions cause the at least one physical processor to compute the parameters of the adaptive filter and generate the intermediate estimate in a time-frequency domain.
Clause 12. The system of clause 9, wherein the adaptive filter comprises a multichannel Wiener filter and the parameters are computed online using recursive estimates of cross- and auto-covariance matrices of the input audio and the intermediate estimate.
Clause 13. The system of clause 9, wherein the second machine-learning model applies complex spectral masking to jointly refine magnitude and phase of the filtered audio signal to produce the enhanced audio signal.
Clause 14. The system of clause 9, wherein the first machine-learning model includes a frequency-dependent spatial processing block comprising per-frequency multiple-input-multiple-output convolutions followed by a recurrent temporal processing block.
Clause 15. The system of clause 14, wherein the recurrent temporal processing block comprises split gated recurrent unit layers configured to process feature segments in parallel under causality constraints.
Clause 16. The system of clause 9, wherein the first and second machine-learning models are jointly trained end-to-end using a composite objective comprising at least one of target reconstruction loss, phase consistency loss, perceptual quality loss, and artifact suppression loss.
Clause 17. A non-transitory computer-readable medium comprising computer-executable instructions that, when executed by at least one physical processor of a computing device, cause the computing device to: generate, by a first machine-learning model, an intermediate estimate of a target signal within input audio; compute, based on the estimate and the input audio, parameters of an adaptive filter; apply the adaptive filter to the input audio to produce a filtered audio signal; and generate, by a second machine-learning model, an enhanced audio signal based at least in part on the filtered signal, wherein the first and second models have been jointly trained end-to-end to enhance the target signal.
Clause 18. The non-transitory computer-readable medium of clause 17, wherein the input audio comprises multichannel audio captured by a microphone array and the adaptive filter comprises a spatial filter.
Clause 19. The non-transitory computer-readable medium of clause 17, wherein the computer-executable instructions further cause the at least one physical processor to transform the input audio into a time-frequency representation, wherein the computer-executable instructions cause the at least one physical processor to compute the parameters of the adaptive filter and generate the intermediate estimate in a time-frequency domain.
Clause 20. The non-transitory computer-readable medium of clause 17, wherein the adaptive filter comprises a multichannel Wiener filter and the parameters are computed online using recursive estimates of cross- and auto-covariance matrices of the input audio and the intermediate estimate.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

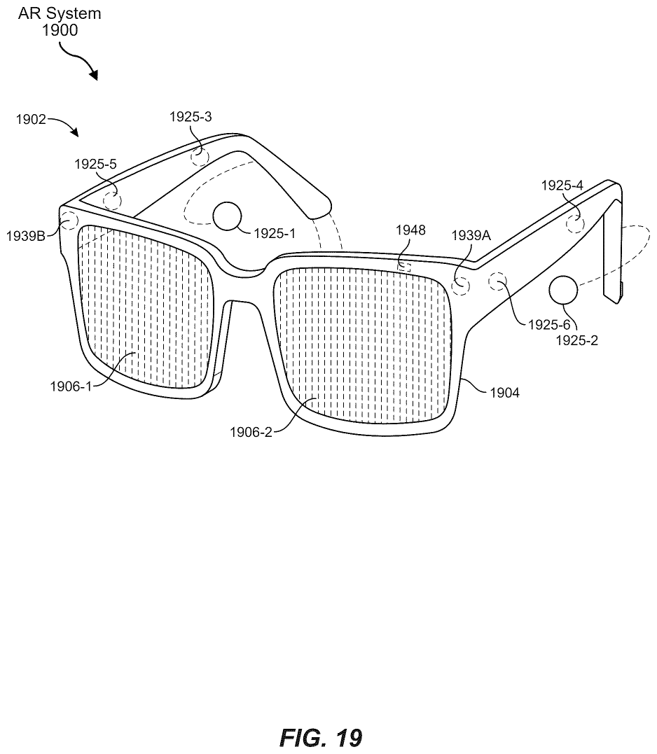

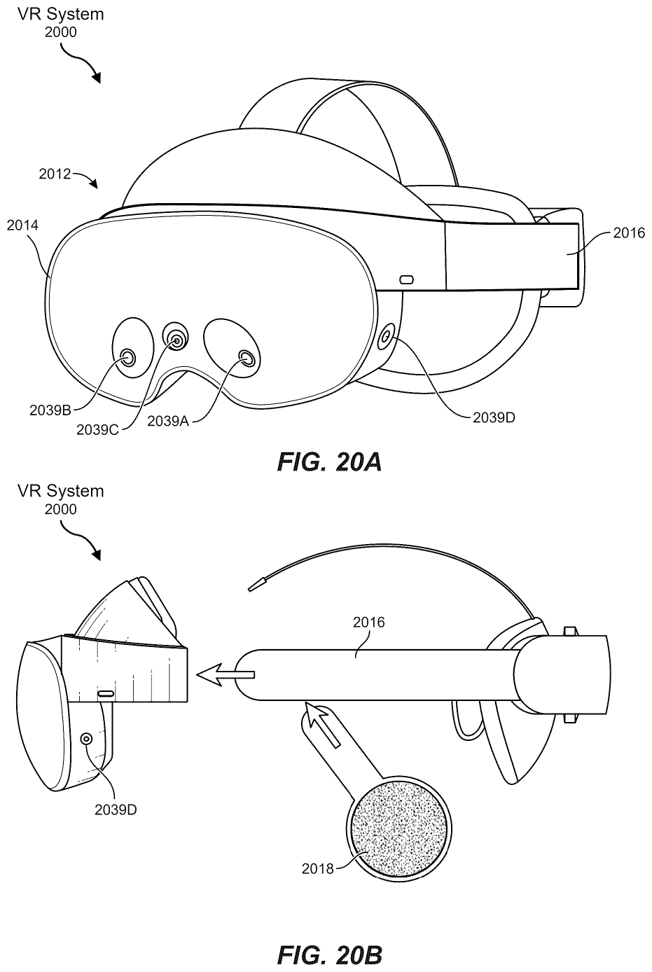

AR systems may be implemented in a variety of different form factors and configurations. Some AR systems may be designed to work without near-eye displays (NEDs). Other AR systems may include a NED that also provides visibility into the real world (such as, e.g., augmented-reality system 1900 in FIG. 19) or that visually immerses a user in an artificial reality (such as, e.g., virtual-reality system 2000 in FIGS. 20A and 20B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

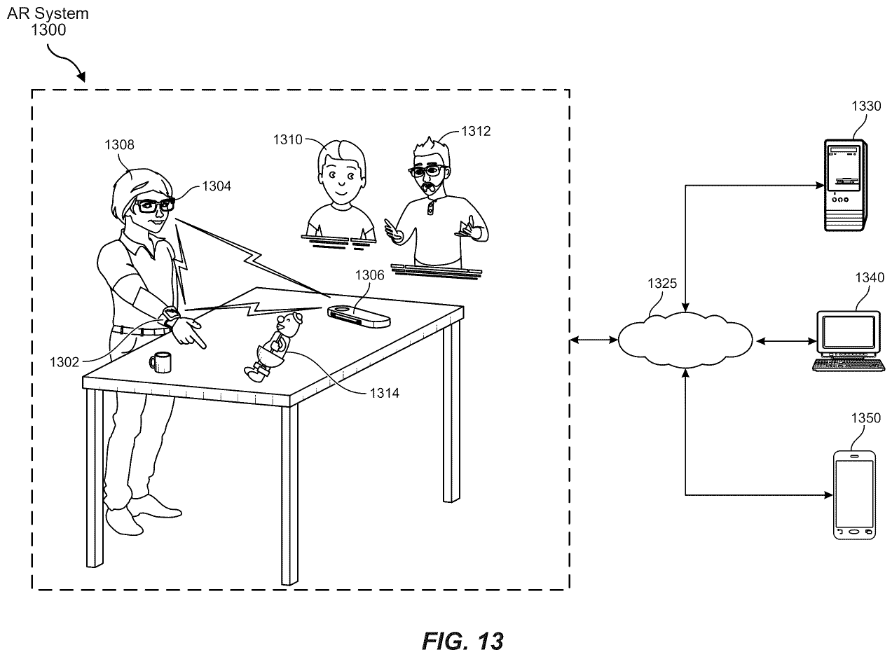

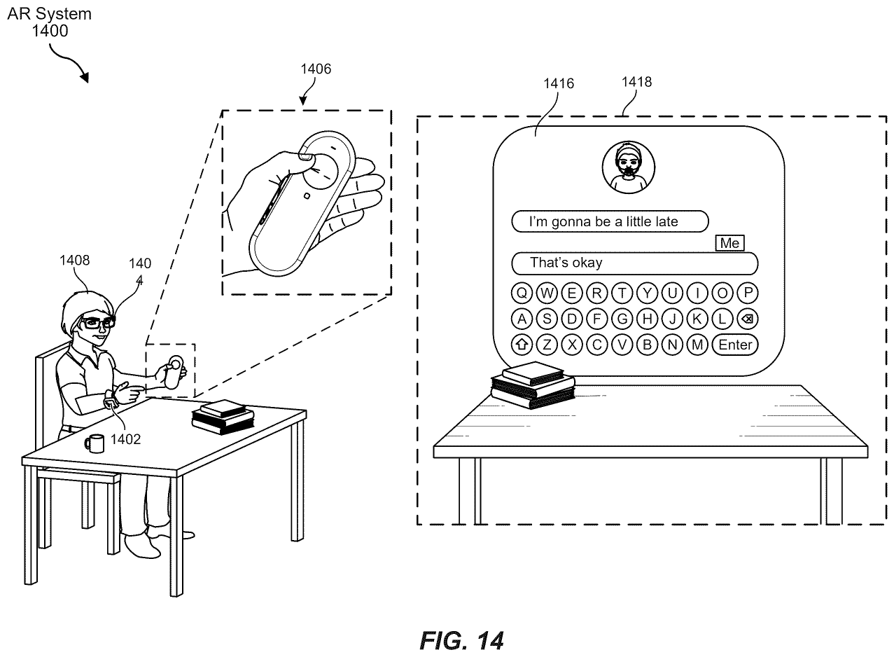

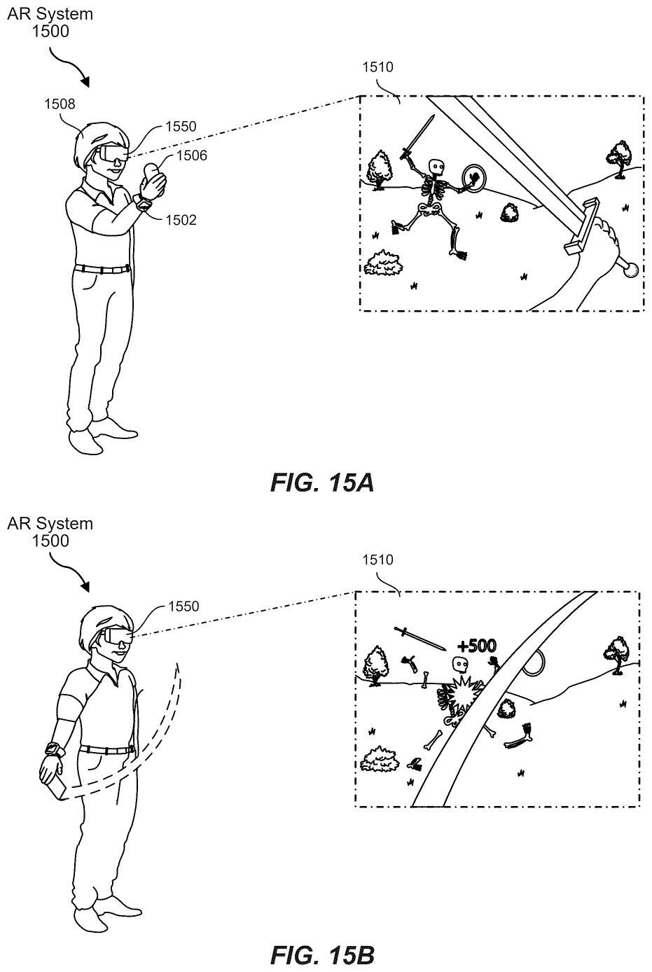

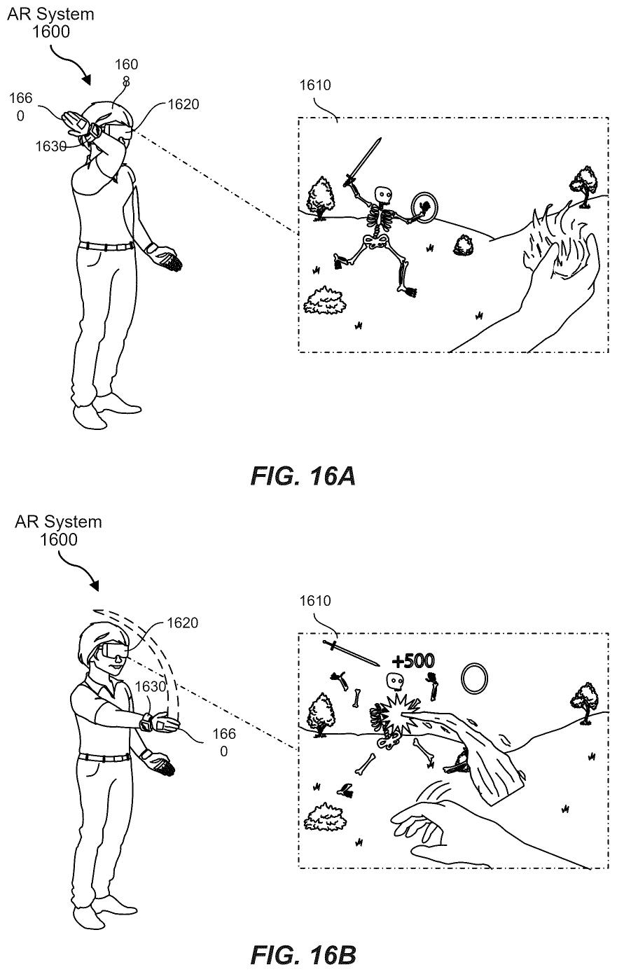

FIGS. 13-16B illustrate example artificial-reality (AR) systems in accordance with some embodiments. FIG. 13 shows a first AR system 1300 and first example user interactions using a wrist-wearable device 1302, a head-wearable device (e.g., AR glasses 1900), and/or a handheld intermediary processing device (HIPD) 1306. FIG. 14 shows a second AR system 1400 and second example user interactions using a wrist-wearable device 1402, AR glasses 1404, and/or an HIPD 1406. FIGS. 15A and 15B show a third AR system 1500 and third example user 1508 interactions using a wrist-wearable device 1502, a head-wearable device (e.g., VR headset 1550), and/or an HIPD 1506. FIGS. 16A and 16B show a fourth AR system 1600 and fourth example user 1608 interactions using a wrist-wearable device 1630, VR headset 1620, and/or a haptic device 1660 (e.g., wearable gloves).

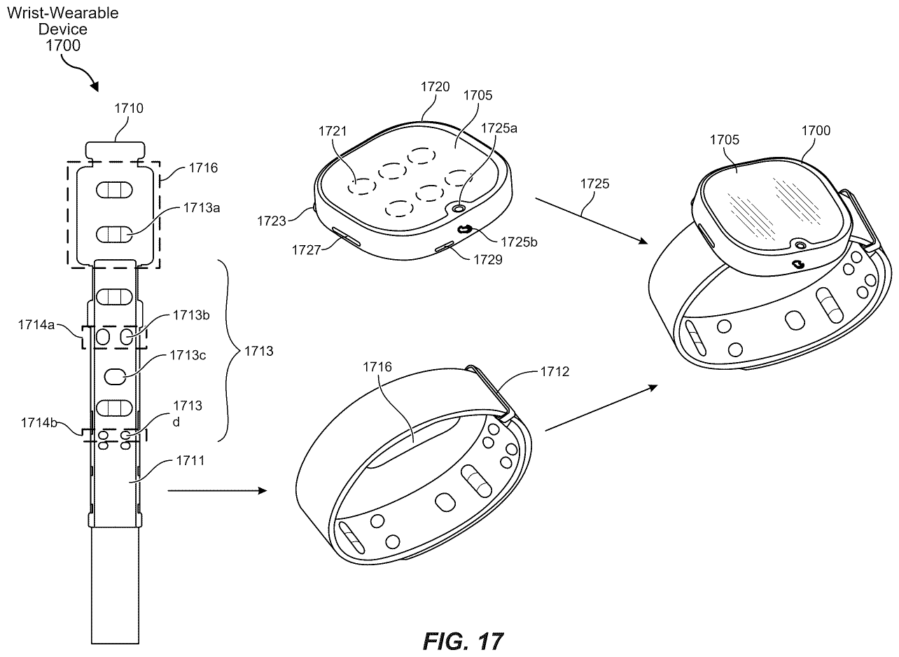

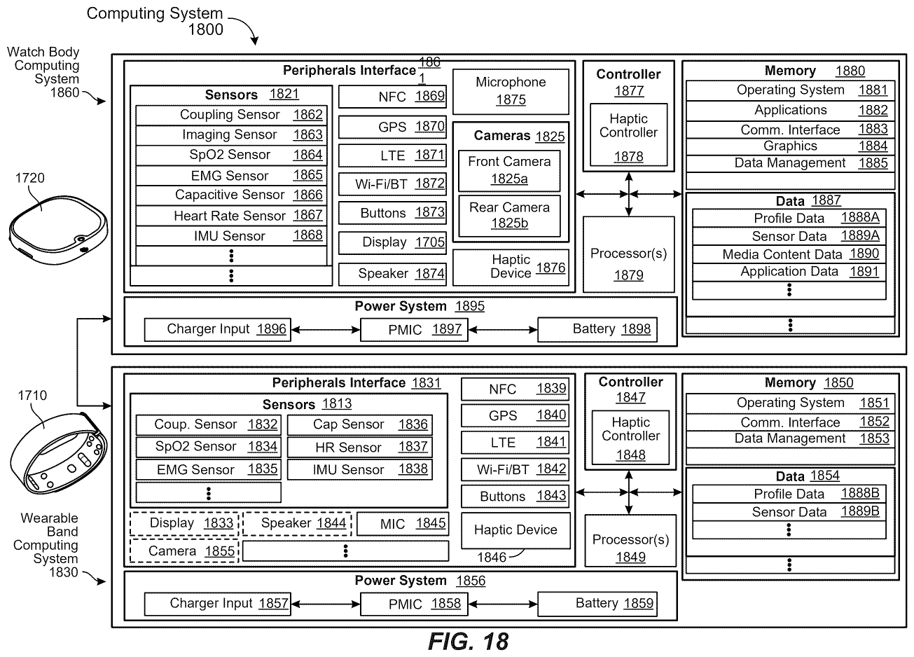

A wrist-wearable device 1700, which can be used for wrist-wearable device 1302, 1402, 1502, 1630, and one or more of its components, are described below in reference to FIGS. 17 and 18; head-wearable devices 1900 and 2000, which can respectively be used for AR glasses 1304, 1404 or VR headset 1550, 1620, and their one or more components are described below in reference to FIGS. 19-21.

Referring to FIG. 13, wrist-wearable device 1302, AR glasses 1304, and/or HIPD 1306 can communicatively couple via a network 1325 (e.g., cellular, near field, Wi-Fi, personal area network, wireless LAN, etc.). Additionally, wrist-wearable device 1302, AR glasses 1304, and/or HIPD 1306 can also communicatively couple with one or more servers 1330, computers 1340 (e.g., laptops, computers, etc.), mobile devices 1350 (e.g., smartphones, tablets, etc.), and/or other electronic devices via network 1325 (e.g., cellular, near field, Wi-Fi, personal area network, wireless LAN, etc.).

In FIG. 13, a user 1308 is shown wearing wrist-wearable device 1302 and AR glasses 1304 and having HIPD 1306 on their desk. The wrist-wearable device 1302, AR glasses 1304, and HIPD 1306 facilitate user interaction with an AR environment. In particular, as shown by first AR system 1300, wrist-wearable device 1302, AR glasses 1304, and/or HIPD 1306 cause presentation of one or more avatars 1310, digital representations of contacts 1312, and virtual objects 1314. As discussed below, user 1308 can interact with one or more avatars 1310, digital representations of contacts 1312, and virtual objects 1314 via wrist-wearable device 1302, AR glasses 1304, and/or HIPD 1306.

User 1308 can use any of wrist-wearable device 1302, AR glasses 1304, and/or HIPD 1306 to provide user inputs. For example, user 1308 can perform one or more hand gestures that are detected by wrist-wearable device 1302 (e.g., using one or more EMG sensors and/or IMUs, described below in reference to FIGS. 17 and 18) and/or AR glasses 1304 (e.g., using one or more image sensor or camera, described below in reference to FIGS. 19-10) to provide a user input. Alternatively, or additionally, user 1308 can provide a user input via one or more touch surfaces of wrist-wearable device 1302, AR glasses 1304, HIPD 1306, and/or voice commands captured by a microphone of wrist-wearable device 1302, AR glasses 1304, and/or HIPD 1306. In some embodiments, wrist-wearable device 1302, AR glasses 1304, and/or HIPD 1306 include a digital assistant to help user 1308 in providing a user input (e.g., completing a sequence of operations, suggesting different operations or commands, providing reminders, confirming a command, etc.). In some embodiments, user 1308 can provide a user input via one or more facial gestures and/or facial expressions. For example, cameras of wrist-wearable device 1302, AR glasses 1304, and/or HIPD 1306 can track eyes of user 1308 for navigating a user interface.

Wrist-wearable device 1302, AR glasses 1304, and/or HIPD 1306 can operate alone or in conjunction to allow user 1308 to interact with the AR environment. In some embodiments, HIPD 1306 is configured to operate as a central hub or control center for the wrist-wearable device 1302, AR glasses 1304, and/or another communicatively coupled device. For example, user 1308 can provide an input to interact with the AR environment at any of wrist-wearable device 1302, AR glasses 1304, and/or HIPD 1306, and HIPD 1306 can identify one or more back-end and front-end tasks to cause the performance of the requested interaction and distribute instructions to cause the performance of the one or more back-end and front-end tasks at wrist-wearable device 1302, AR glasses 1304, and/or HIPD 1306. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. Error! Reference source not found.-Error! Reference source not found., HIPD 1306 can perform the back-end tasks and provide wrist-wearable device 1302 and/or AR glasses 1304 operational data corresponding to the performed back-end tasks such that wrist-wearable device 1302 and/or AR glasses 1304 can perform the front-end tasks. In this way, HIPD 1306, which has more computational resources and greater thermal headroom than wrist-wearable device 1302 and/or AR glasses 1304, performs computationally intensive tasks and reduces the computer resource utilization and/or power usage of wrist-wearable device 1302 and/or AR glasses 1304.

In the example shown by first AR system 1300, HIPD 1306 identifies one or more back-end tasks and front-end tasks associated with a user request to initiate an AR video call with one or more other users (represented by avatar 1310 and the digital representation of contact 1312) and distributes instructions to cause the performance of the one or more back-end tasks and front-end tasks. In particular, HIPD 1306 performs back-end tasks for processing and/or rendering image data (and other data) associated with the AR video call and provides operational data associated with the performed back-end tasks to AR glasses 1304 such that the AR glasses 1304 perform front-end tasks for presenting the AR video call (e.g., presenting avatar 1310 and digital representation of contact 1312).

In some embodiments, HIPD 1306 can operate as a focal or anchor point for causing the presentation of information. This allows user 1308 to be generally aware of where information is presented. For example, as shown in first AR system 1300, avatar 1310 and the digital representation of contact 1312 are presented above HIPD 1306. In particular, HIPD 1306 and AR glasses 1304 operate in conjunction to determine a location for presenting avatar 1310 and the digital representation of contact 1312. In some embodiments, information can be presented a predetermined distance from HIPD 1306 (e.g., within 5 meters). For example, as shown in first AR system 1300, virtual object 1314 is presented on the desk some distance from HIPD 1306. Similar to the above example, HIPD 1306 and AR glasses 1304 can operate in conjunction to determine a location for presenting virtual object 1314. Alternatively, in some embodiments, presentation of information is not bound by HIPD 1306. More specifically, avatar 1310, digital representation of contact 1312, and virtual object 1314 do not have to be presented within a predetermined distance of HIPD 1306.

User inputs provided at wrist-wearable device 1302, AR glasses 1304, and/or HIPD 1306 are coordinated such that the user can use any device to initiate, continue, and/or complete an operation. For example, user 1308 can provide a user input to AR glasses 1304 to cause AR glasses 1304 to present virtual object 1314 and, while virtual object 1314 is presented by AR glasses 1304, user 1308 can provide one or more hand gestures via wrist-wearable device 1302 to interact and/or manipulate virtual object 1314.

FIG. 14 shows a user 1408 wearing a wrist-wearable device 1402 and AR glasses 1404, and holding an HIPD 1406. In second AR system 1400, the wrist-wearable device 1402, AR glasses 1404, and/or HIPD 1406 are used to receive and/or provide one or more messages to a contact of user 1408. In particular, wrist-wearable device 1402, AR glasses 1404, and/or HIPD 1406 detect and coordinate one or more user inputs to initiate a messaging application and prepare a response to a received message via the messaging application.

In some embodiments, user 1408 initiates, via a user input, an application on wrist-wearable device 1402, AR glasses 1404, and/or HIPD 1406 that causes the application to initiate on at least one device. For example, in second AR system 1400, user 1408 performs a hand gesture associated with a command for initiating a messaging application (represented by messaging user interface 1416), wrist-wearable device 1402 detects the hand gesture and, based on a determination that user 1408 is wearing AR glasses 1404, causes AR glasses 1404 to present a messaging user interface 1416 of the messaging application. AR glasses 1404 can present messaging user interface 1416 to user 1408 via its display (e.g., as shown by a field of view 1418 of user 1408). In some embodiments, the application is initiated and executed on the device (e.g., wrist-wearable device 1402, AR glasses 1404, and/or HIPD 1406) that detects the user input to initiate the application, and the device provides another device operational data to cause the presentation of the messaging application. For example, wrist-wearable device 1402 can detect the user input to initiate a messaging application, initiate and run the messaging application, and provide operational data to AR glasses 1404 and/or HIPD 1406 to cause presentation of the messaging application. Alternatively, the application can be initiated and executed at a device other than the device that detected the user input. For example, wrist-wearable device 1402 can detect the hand gesture associated with initiating the messaging application and cause HIPD 1406 to run the messaging application and coordinate the presentation of the messaging application.

Further, user 1408 can provide a user input provided at wrist-wearable device 1402, AR glasses 1404, and/or HIPD 1406 to continue and/or complete an operation initiated at another device. For example, after initiating the messaging application via wrist-wearable device 1402 and while AR glasses 1404 present messaging user interface 1416, user 1408 can provide an input at HIPD 1406 to prepare a response (e.g., shown by the swipe gesture performed on HIPD 1406). Gestures performed by user 1408 on HIPD 1406 can be provided and/or displayed on another device. For example, a swipe gestured performed on HIPD 1406 is displayed on a virtual keyboard of messaging user interface 1416 displayed by AR glasses 1404.

In some embodiments, wrist-wearable device 1402, AR glasses 1404, HIPD 1406, and/or any other communicatively coupled device can present one or more notifications to user 1408. The notification can be an indication of a new message, an incoming call, an application update, a status update, etc. User 1408 can select the notification via wrist-wearable device 1402, AR glasses 1404, and/or HIPD 1406 and can cause presentation of an application or operation associated with the notification on at least one device. For example, user 1408 can receive a notification that a message was received at wrist-wearable device 1402, AR glasses 1404, HIPD 1406, and/or any other communicatively coupled device and can then provide a user input at wrist-wearable device 1402, AR glasses 1404, and/or HIPD 1406 to review the notification, and the device detecting the user input can cause an application associated with the notification to be initiated and/or presented at wrist-wearable device 1402, AR glasses 1404, and/or HIPD 1406.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1404 can present to user 1408 game application data, and HIPD 1406 can be used as a controller to provide inputs to the game. Similarly, user 1408 can use wrist-wearable device 1402 to initiate a camera of AR glasses 1404, and user 1408 can use wrist-wearable device 1402, AR glasses 1404, and/or HIPD 1406 to manipulate the image capture (e.g., zoom in or out, apply filters, etc.) and capture image data.

Users may interact with the devices disclosed herein in a variety of ways. For example, as shown in FIGS. 15A and 15B, a user 1508 may interact with an AR system 1500 by donning a VR headset 1550 while holding HIPD 1506 and wearing wrist-wearable device 1502. In this example, AR system 1500 may enable a user to interact with a game 1510 by swiping their arm. One or more of VR headset 1550, HIPD 1506, and wrist-wearable device 1502 may detect this gesture and, in response, may display a sword strike in game 1510. Similarly, in FIGS. 16A and 16B, a user 1608 may interact with an AR system 1600 by donning a VR headset 1620 while wearing haptic device 1660 and wrist-wearable device 1630. In this example, AR system 1600 may enable a user to interact with a game 1610 by swiping their arm. One or more of VR headset 1620, haptic device 1660, and wrist-wearable device 1630 may detect this gesture and, in response, may display a spell being cast in game 1510.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1902.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 17 and 18 illustrate an example wrist-wearable device 1700 and an example computer system 1800, in accordance with some embodiments. Wrist-wearable device 1700 is an instance of wearable device 1302 described in FIG. 13 herein, such that the wearable device 1302 should be understood to have the features of the wrist-wearable device 1700 and vice versa. FIG. 18 illustrates components of the wrist-wearable device 1700, which can be used individually or in combination, including combinations that include other electronic devices and/or electronic components.

FIG. 17 shows a wearable band 1710 and a watch body 1720 (or capsule) being coupled, as discussed below, to form wrist-wearable device 1700. Wrist-wearable device 1700 can perform various functions and/or operations associated with navigating through user interfaces and selectively opening applications as well as the functions and/or operations described above with reference to FIGS. 13-16B.

As will be described in more detail below, operations executed by wrist-wearable device 1700 can include (i) presenting content to a user (e.g., displaying visual content via a display 1705), (ii) detecting (e.g., sensing) user input (e.g., sensing a touch on peripheral button 1723 and/or at a touch screen of the display 1705, a hand gesture detected by sensors (e.g., biopotential sensors)), (iii) sensing biometric data (e.g., neuromuscular signals, heart rate, temperature, sleep, etc.) via one or more sensors 1713, messaging (e.g., text, speech, video, etc.); image capture via one or more imaging devices or cameras 1725, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1720, independently in wearable band 1710, and/or via an electronic communication between watch body 1720 and wearable band 1710. In some embodiments, functions can be executed on wrist-wearable device 1700 while an AR environment is being presented (e.g., via one of AR systems 1300 to 1600). The wearable devices described herein can also be used with other types of AR environments.

Wearable band 1710 can be configured to be worn by a user such that an inner surface of a wearable structure 1711 of wearable band 1710 is in contact with the user's skin. In this example, when worn by a user, sensors 1713 may contact the user's skin. In some examples, one or more of sensors 1713 can sense biometric data such as a user's heart rate, a saturated oxygen level, temperature, sweat level, neuromuscular signals, or a combination thereof. One or more of sensors 1713 can also sense data about a user's environment including a user's motion, altitude, location, orientation, gait, acceleration, position, or a combination thereof. In some embodiment, one or more of sensors 1713 can be configured to track a position and/or motion of wearable band 1710. One or more of sensors 1713 can include any of the sensors defined above and/or discussed below with respect to FIG. 17.

One or more of sensors 1713 can be distributed on an inside and/or an outside surface of wearable band 1710. In some embodiments, one or more of sensors 1713 are uniformly spaced along wearable band 1710. Alternatively, in some embodiments, one or more of sensors 1713 are positioned at distinct points along wearable band 1710. As shown in FIG. 17, one or more of sensors 1713 can be the same or distinct. For example, in some embodiments, one or more of sensors 1713 can be shaped as a pill (e.g., sensor 1713a), an oval, a circle a square, an oblong (e.g., sensor 1713c) and/or any other shape that maintains contact with the user's skin (e.g., such that neuromuscular signal and/or other biometric data can be accurately measured at the user's skin). In some embodiments, one or more sensors of 1713 are aligned to form pairs of sensors (e.g., for sensing neuromuscular signals based on differential sensing within each respective sensor). For example, sensor 1713b may be aligned with an adjacent sensor to form sensor pair 1714a and sensor 1713d may be aligned with an adjacent sensor to form sensor pair 1714b. In some embodiments, wearable band 1710 does not have a sensor pair. Alternatively, in some embodiments, wearable band 1710 has a predetermined number of sensor pairs (one pair of sensors, three pairs of sensors, four pairs of sensors, six pairs of sensors, sixteen pairs of sensors, etc.).

Wearable band 1710 can include any suitable number of sensors 1713. In some embodiments, the number and arrangement of sensors 1713 depends on the particular application for which wearable band 1710 is used. For instance, wearable band 1710 can be configured as an armband, wristband, or chest-band that include a plurality of sensors 1713 with different number of sensors 1713, a variety of types of individual sensors with the plurality of sensors 1713, and different arrangements for each use case, such as medical use cases as compared to gaming or general day-to-day use cases.

In accordance with some embodiments, wearable band 1710 further includes an electrical ground electrode and a shielding electrode. The electrical ground and shielding electrodes, like the sensors 1713, can be distributed on the inside surface of the wearable band 1710 such that they contact a portion of the user's skin. For example, the electrical ground and shielding electrodes can be at an inside surface of a coupling mechanism 1716 or an inside surface of a wearable structure 1711. The electrical ground and shielding electrodes can be formed and/or use the same components as sensors 1713. In some embodiments, wearable band 1710 includes more than one electrical ground electrode and more than one shielding electrode.

Sensors 1713 can be formed as part of wearable structure 1711 of wearable band 1710. In some embodiments, sensors 1713 are flush or substantially flush with wearable structure 1711 such that they do not extend beyond the surface of wearable structure 1711. While flush with wearable structure 1711, sensors 1713 are still configured to contact the user's skin (e.g., via a skin-contacting surface). Alternatively, in some embodiments, sensors 1713 extend beyond wearable structure 1711 a predetermined distance (e.g., 0.1-2 mm) to make contact and depress into the user's skin. In some embodiment, sensors 1713 are coupled to an actuator (not shown) configured to adjust an extension height (e.g., a distance from the surface of wearable structure 1711) of sensors 1713 such that sensors 1713 make contact and depress into the user's skin. In some embodiments, the actuators adjust the extension height between 0.01 mm-1.2 mm. This may allow a the user to customize the positioning of sensors 1713 to improve the overall comfort of the wearable band 1710 when worn while still allowing sensors 1713 to contact the user's skin. In some embodiments, sensors 1713 are indistinguishable from wearable structure 1711 when worn by the user.

Wearable structure 1711 can be formed of an elastic material, elastomers, etc., configured to be stretched and fitted to be worn by the user. In some embodiments, wearable structure 1711 is a textile or woven fabric. As described above, sensors 1713 can be formed as part of a wearable structure 1711. For example, sensors 1713 can be molded into the wearable structure 1711, be integrated into a woven fabric (e.g., sensors 1713 can be sewn into the fabric and mimic the pliability of fabric and can and/or be constructed from a series woven strands of fabric).

Wearable structure 1711 can include flexible electronic connectors that interconnect sensors 1713, the electronic circuitry, and/or other electronic components (described below in reference to FIG. 18) that are enclosed in wearable band 1710. In some embodiments, the flexible electronic connectors are configured to interconnect sensors 1713, the electronic circuitry, and/or other electronic components of wearable band 1710 with respective sensors and/or other electronic components of another electronic device (e.g., watch body 1720). The flexible electronic connectors are configured to move with wearable structure 1711 such that the user adjustment to wearable structure 1711 (e.g., resizing, pulling, folding, etc.) does not stress or strain the electrical coupling of components of wearable band 1710.

As described above, wearable band 1710 is configured to be worn by a user. In particular, wearable band 1710 can be shaped or otherwise manipulated to be worn by a user. For example, wearable band 1710 can be shaped to have a substantially circular shape such that it can be configured to be worn on the user's lower arm or wrist. Alternatively, wearable band 1710 can be shaped to be worn on another body part of the user, such as the user's upper arm (e.g., around a bicep), forearm, chest, legs, etc. Wearable band 1710 can include a retaining mechanism 1712 (e.g., a buckle, a hook and loop fastener, etc.) for securing wearable band 1710 to the user's wrist or other body part. While wearable band 1710 is worn by the user, sensors 1713 sense data (referred to as sensor data) from the user's skin. In some examples, sensors 1713 of wearable band 1710 obtain (e.g., sense and record) neuromuscular signals.

The sensed data (e.g., sensed neuromuscular signals) can be used to detect and/or determine the user's intention to perform certain motor actions. In some examples, sensors 1713 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1705 of wrist-wearable device 1700 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1713 can be used to provide a user with an enhanced interaction with a physical object (e.g., devices communicatively coupled with wearable band 1710) and/or a virtual object in an artificial-reality application generated by an artificial-reality system (e.g., user interface objects presented on the display 1705, or another computing device (e.g., a smartphone)).

In some embodiments, wearable band 1710 includes one or more haptic devices 1846 (e.g., a vibratory haptic actuator) that are configured to provide haptic feedback (e.g., a cutaneous and/or kinesthetic sensation, etc.) to the user's skin. Sensors 1713 and/or haptic devices 1846 (shown in FIG. 18) can be configured to operate in conjunction with multiple applications including, without limitation, health monitoring, social media, games, and artificial reality (e.g., the applications associated with artificial reality).

Wearable band 1710 can also include coupling mechanism 1716 for detachably coupling a capsule (e.g., a computing unit) or watch body 1720 (via a coupling surface of the watch body 1720) to wearable band 1710. For example, a cradle or a shape of coupling mechanism 1716 can correspond to shape of watch body 1720 of wrist-wearable device 1700. In particular, coupling mechanism 1716 can be configured to receive a coupling surface proximate to the bottom side of watch body 1720 (e.g., a side opposite to a front side of watch body 1720 where display 1705 is located), such that a user can push watch body 1720 downward into coupling mechanism 1716 to attach watch body 1720 to coupling mechanism 1716. In some embodiments, coupling mechanism 1716 can be configured to receive a top side of the watch body 1720 (e.g., a side proximate to the front side of watch body 1720 where display 1705 is located) that is pushed upward into the cradle, as opposed to being pushed downward into coupling mechanism 1716. In some embodiments, coupling mechanism 1716 is an integrated component of wearable band 1710 such that wearable band 1710 and coupling mechanism 1716 are a single unitary structure. In some embodiments, coupling mechanism 1716 is a type of frame or shell that allows watch body 1720 coupling surface to be retained within or on wearable band 1710 coupling mechanism 1716 (e.g., a cradle, a tracker band, a support base, a clasp, etc.).

Coupling mechanism 1716 can allow for watch body 1720 to be detachably coupled to the wearable band 1710 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1720 to wearable band 1710 and to decouple the watch body 1720 from the wearable band 1710. For example, a user can twist, slide, turn, push, pull, or rotate watch body 1720 relative to wearable band 1710, or a combination thereof, to attach watch body 1720 to wearable band 1710 and to detach watch body 1720 from wearable band 1710. Alternatively, as discussed below, in some embodiments, the watch body 1720 can be decoupled from the wearable band 1710 by actuation of a release mechanism 1729.

Wearable band 1710 can be coupled with watch body 1720 to increase the functionality of wearable band 1710 (e.g., converting wearable band 1710 into wrist-wearable device 1700, adding an additional computing unit and/or battery to increase computational resources and/or a battery life of wearable band 1710, adding additional sensors to improve sensed data, etc.). As described above, wearable band 1710 and coupling mechanism 1716 are configured to operate independently (e.g., execute functions independently) from watch body 1720. For example, coupling mechanism 1716 can include one or more sensors 1713 that contact a user's skin when wearable band 1710 is worn by the user, with or without watch body 1720 and can provide sensor data for determining control commands.

A user can detach watch body 1720 from wearable band 1710 to reduce the encumbrance of wrist-wearable device 1700 to the user. For embodiments in which watch body 1720 is removable, watch body 1720 can be referred to as a removable structure, such that in these embodiments wrist-wearable device 1700 includes a wearable portion (e.g., wearable band 1710) and a removable structure (e.g., watch body 1720).

Turning to watch body 1720, in some examples watch body 1720 can have a substantially rectangular or circular shape. Watch body 1720 is configured to be worn by the user on their wrist or on another body part. More specifically, watch body 1720 is sized to be easily carried by the user, attached on a portion of the user's clothing, and/or coupled to wearable band 1710 (forming the wrist-wearable device 1700). As described above, watch body 1720 can have a shape corresponding to coupling mechanism 1716 of wearable band 1710. In some embodiments, watch body 1720 includes a single release mechanism 1729 or multiple release mechanisms (e.g., two release mechanisms 1729 positioned on opposing sides of watch body 1720, such as spring-loaded buttons) for decoupling watch body 1720 from wearable band 1710. Release mechanism 1729 can include, without limitation, a button, a knob, a plunger, a handle, a lever, a fastener, a clasp, a dial, a latch, or a combination thereof.

A user can actuate release mechanism 1729 by pushing, turning, lifting, depressing, shifting, or performing other actions on release mechanism 1729. Actuation of release mechanism 1729 can release (e.g., decouple) watch body 1720 from coupling mechanism 1716 of wearable band 1710, allowing the user to use watch body 1720 independently from wearable band 1710 and vice versa. For example, decoupling watch body 1720 from wearable band 1710 can allow a user to capture images using rear-facing camera 1725b. Although release mechanism 1729 is shown positioned at a corner of watch body 1720, release mechanism 1729 can be positioned anywhere on watch body 1720 that is convenient for the user to actuate. In addition, in some embodiments, wearable band 1710 can also include a respective release mechanism for decoupling watch body 1720 from coupling mechanism 1716. In some embodiments, release mechanism 1729 is optional and watch body 1720 can be decoupled from coupling mechanism 1716 as described above (e.g., via twisting, rotating, etc.).

Watch body 1720 can include one or more peripheral buttons 1723 and 1727 for performing various operations at watch body 1720. For example, peripheral buttons 1723 and 1727 can be used to turn on or wake (e.g., transition from a sleep state to an active state) display 1705, unlock watch body 1720, increase or decrease a volume, increase or decrease a brightness, interact with one or more applications, interact with one or more user interfaces, etc. Additionally or alternatively, in some embodiments, display 1705 operates as a touch screen and allows the user to provide one or more inputs for interacting with watch body 1720.

In some embodiments, watch body 1720 includes one or more sensors 1721. Sensors 1721 of watch body 1720 can be the same or distinct from sensors 1713 of wearable band 1710. Sensors 1721 of watch body 1720 can be distributed on an inside and/or an outside surface of watch body 1720. In some embodiments, sensors 1721 are configured to contact a user's skin when watch body 1720 is worn by the user. For example, sensors 1721 can be placed on the bottom side of watch body 1720 and coupling mechanism 1716 can be a cradle with an opening that allows the bottom side of watch body 1720 to directly contact the user's skin. Alternatively, in some embodiments, watch body 1720 does not include sensors that are configured to contact the user's skin (e.g., including sensors internal and/or external to the watch body 1720 that are configured to sense data of watch body 1720 and the surrounding environment). In some embodiments, sensors 1721 are configured to track a position and/or motion of watch body 1720.

Watch body 1720 and wearable band 1710 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1720 and wearable band 1710 can share data sensed by sensors 1713 and 1721, as well as application and device specific information (e.g., active and/or available applications, output devices (e.g., displays, speakers, etc.), input devices (e.g., touch screens, microphones, imaging sensors, etc.).

In some embodiments, watch body 1720 can include, without limitation, a front-facing camera 1725a and/or a rear-facing camera 1725b, sensors 1721 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1863), a touch sensor, a sweat sensor, etc.). In some embodiments, watch body 1720 can include one or more haptic devices 1876 (e.g., a vibratory haptic actuator) that is configured to provide haptic feedback (e.g., a cutaneous and/or kinesthetic sensation, etc.) to the user. Sensors 1821 and/or haptic device 1876 can also be configured to operate in conjunction with multiple applications including, without limitation, health monitoring applications, social media applications, game applications, and artificial reality applications (e.g., the applications associated with artificial reality).

As described above, watch body 1720 and wearable band 1710, when coupled, can form wrist-wearable device 1700. When coupled, watch body 1720 and wearable band 1710 may operate as a single device to execute functions (operations, detections, communications, etc.) described herein. In some embodiments, each device may be provided with particular instructions for performing the one or more operations of wrist-wearable device 1700. For example, in accordance with a determination that watch body 1720 does not include neuromuscular signal sensors, wearable band 1710 can include alternative instructions for performing associated instructions (e.g., providing sensed neuromuscular signal data to watch body 1720 via a different electronic device). Operations of wrist-wearable device 1700 can be performed by watch body 1720 alone or in conjunction with wearable band 1710 (e.g., via respective processors and/or hardware components) and vice versa. In some embodiments, operations of wrist-wearable device 1700, watch body 1720, and/or wearable band 1710 can be performed in conjunction with one or more processors and/or hardware components.

As described below with reference to the block diagram of FIG. 18, wearable band 1710 and/or watch body 1720 can each include independent resources required to independently execute functions. For example, wearable band 1710 and/or watch body 1720 can each include a power source (e.g., a battery), a memory, data storage, a processor (e.g., a central processing unit (CPU)), communications, a light source, and/or input/output devices.

FIG. 18 shows block diagrams of a computing system 1830 corresponding to wearable band 1710 and a computing system 1860 corresponding to watch body 1720 according to some embodiments. Computing system 1800 of wrist-wearable device 1700 may include a combination of components of wearable band computing system 1830 and watch body computing system 1860, in accordance with some embodiments.

Watch body 1720 and/or wearable band 1710 can include one or more components shown in watch body computing system 1860. In some embodiments, a single integrated circuit may include all or a substantial portion of the components of watch body computing system 1860 included in a single integrated circuit. Alternatively, in some embodiments, components of the watch body computing system 1860 may be included in a plurality of integrated circuits that are communicatively coupled. In some embodiments, watch body computing system 1860 may be configured to couple (e.g., via a wired or wireless connection) with wearable band computing system 1830, which may allow the computing systems to share components, distribute tasks, and/or perform other operations described herein (individually or as a single device).

Watch body computing system 1860 can include one or more processors 1879, a controller 1877, a peripherals interface 1861, a power system 1895, and memory (e.g., a memory 1880).

Power system 1895 can include a charger input 1896, a power-management integrated circuit (PMIC) 1897, and a battery 1898. In some embodiments, a watch body 1720 and a wearable band 1710 can have respective batteries (e.g., battery 1898 and 1859) and can share power with each other. Watch body 1720 and wearable band 1710 can receive a charge using a variety of techniques. In some embodiments, watch body 1720 and wearable band 1710 can use a wired charging assembly (e.g., power cords) to receive the charge. Alternatively, or in addition, watch body 1720 and/or wearable band 1710 can be configured for wireless charging. For example, a portable charging device can be designed to mate with a portion of watch body 1720 and/or wearable band 1710 and wirelessly deliver usable power to battery 1898 of watch body 1720 and/or battery 1859 of wearable band 1710. Watch body 1720 and wearable band 1710 can have independent power systems (e.g., power system 1895 and 1856, respectively) to enable each to operate independently. Watch body 1720 and wearable band 1710 can also share power (e.g., one can charge the other) via respective PMICs (e.g., PMICs 1897 and 1858) and charger inputs (e.g., 1857 and 1896) that can share power over power and ground conductors and/or over wireless charging antennas.

In some embodiments, peripherals interface 1861 can include one or more sensors 1821. Sensors 1821 can include one or more coupling sensors 1862 for detecting when watch body 1720 is coupled with another electronic device (e.g., a wearable band 1710). Sensors 1821 can include one or more imaging sensors 1863 (e.g., one or more of cameras 1825, and/or separate imaging sensors 1863 (e.g., thermal-imaging sensors)). In some embodiments, sensors 1821 can include one or more SpO2 sensors 1864. In some embodiments, sensors 1821 can include one or more biopotential-signal sensors (e.g., EMG sensors 1865, which may be disposed on an interior, user-facing portion of watch body 1720 and/or wearable band 1710). In some embodiments, sensors 1821 may include one or more capacitive sensors 1866. In some embodiments, sensors 1821 may include one or more heart rate sensors 1867. In some embodiments, sensors 1821 may include one or more IMU sensors 1868. In some embodiments, one or more IMU sensors 1868 can be configured to detect movement of a user's hand or other location where watch body 1720 is placed or held.

In some embodiments, one or more of sensors 1821 may provide an example human-machine interface. For example, a set of neuromuscular sensors, such as EMG sensors 1865, may be arranged circumferentially around wearable band 1710 with an interior surface of EMG sensors 1865 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1710 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1879. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1865 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1861 includes a near-field communication (NFC) component 1869, a global-position system (GPS) component 1870, a long-term evolution (LTE) component 1871, and/or a Wi-Fi and/or Bluetooth communication component 1872. In some embodiments, peripherals interface 1861 includes one or more buttons 1873 (e.g., peripheral buttons 1723 and 1727 in FIG. 17), which, when selected by a user, cause operation to be performed at watch body 1720. In some embodiments, the peripherals interface 1861 includes one or more indicators, such as a light emitting diode (LED), to provide a user with visual indicators (e.g., message received, low battery, active microphone and/or camera, etc.).

Watch body 1720 can include at least one display 1705 for displaying visual representations of information or data to a user, including user-interface elements and/or three-dimensional virtual objects. The display can also include a touch screen for inputting user inputs, such as touch gestures, swipe gestures, and the like. Watch body 1720 can include at least one speaker 1874 and at least one microphone 1875 for providing audio signals to the user and receiving audio input from the user. The user can provide user inputs through microphone 1875 and can also receive audio output from speaker 1874 as part of a haptic event provided by haptic controller 1878. Watch body 1720 can include at least one camera 1825, including a front camera 1825a and a rear camera 1825b. Cameras 1825 can include ultra-wide-angle cameras, wide angle cameras, fish-eye cameras, spherical cameras, telephoto cameras, depth-sensing cameras, or other types of cameras.

Watch body computing system 1860 can include one or more haptic controllers 1878 and associated componentry (e.g., haptic devices 1876) for providing haptic events at watch body 1720 (e.g., a vibrating sensation or audio output in response to an event at the watch body 1720). Haptic controllers 1878 can communicate with one or more haptic devices 1876, such as electroacoustic devices, including a speaker of the one or more speakers 1874 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1878 can provide haptic events to that are capable of being sensed by a user of watch body 1720. In some embodiments, one or more haptic controllers 1878 can receive input signals from an application of applications 1882.

In some embodiments, wearable band computing system 1830 and/or watch body computing system 1860 can include memory 1880, which can be controlled by one or more memory controllers of controllers 1877. In some embodiments, software components stored in memory 1880 include one or more applications 1882 configured to perform operations at the watch body 1720. In some embodiments, one or more applications 1882 may include games, word processors, messaging applications, calling applications, web browsers, social media applications, media streaming applications, financial applications, calendars, clocks, etc. In some embodiments, software components stored in memory 1880 include one or more communication interface modules 1883 as defined above. In some embodiments, software components stored in memory 1880 include one or more graphics modules 1884 for rendering, encoding, and/or decoding audio and/or visual data and one or more data management modules 1885 for collecting, organizing, and/or providing access to data 1887 stored in memory 1880. In some embodiments, one or more of applications 1882 and/or one or more modules can work in conjunction with one another to perform various tasks at the watch body 1720.

In some embodiments, software components stored in memory 1880 can include one or more operating systems 1881 (e.g., a Linux-based operating system, an Android operating system, etc.). Memory 1880 can also include data 1887. Data 1887 can include profile data 1888A, sensor data 1889A, media content data 1890, and application data 1891.

It should be appreciated that watch body computing system 1860 is an example of a computing system within watch body 1720, and that watch body 1720 can have more or fewer components than shown in watch body computing system 1860, can combine two or more components, and/or can have a different configuration and/or arrangement of the components. The various components shown in watch body computing system 1860 are implemented in hardware, software, firmware, or a combination thereof, including one or more signal processing and/or application-specific integrated circuits.

Turning to the wearable band computing system 1830, one or more components that can be included in wearable band 1710 are shown. Wearable band computing system 1830 can include more or fewer components than shown in watch body computing system 1860, can combine two or more components, and/or can have a different configuration and/or arrangement of some or all of the components. In some embodiments, all, or a substantial portion of the components of wearable band computing system 1830 are included in a single integrated circuit. Alternatively, in some embodiments, components of wearable band computing system 1830 are included in a plurality of integrated circuits that are communicatively coupled. As described above, in some embodiments, wearable band computing system 1830 is configured to couple (e.g., via a wired or wireless connection) with watch body computing system 1860, which allows the computing systems to share components, distribute tasks, and/or perform other operations described herein (individually or as a single device).

Wearable band computing system 1830, similar to watch body computing system 1860, can include one or more processors 1849, one or more controllers 1847 (including one or more haptics controllers 1848), a peripherals interface 1831 that can includes one or more sensors 1813 and other peripheral devices, a power source (e.g., a power system 1856), and memory (e.g., a memory 1850) that includes an operating system (e.g., an operating system 1851), data (e.g., data 1854 including profile data 1888B, sensor data 1889B, etc.), and one or more modules (e.g., a communications interface module 1852, a data management module 1853, etc.).

One or more of sensors 1813 can be analogous to sensors 1821 of watch body computing system 1860. For example, sensors 1813 can include one or more coupling sensors 1832, one or more SpO2 sensors 1834, one or more EMG sensors 1835, one or more capacitive sensors 1836, one or more heart rate sensors 1837, and one or more IMU sensors 1838.

Peripherals interface 1831 can also include other components analogous to those included in peripherals interface 1861 of watch body computing system 1860, including an NFC component 1839, a GPS component 1840, an LTE component 1841, a Wi-Fi and/or Bluetooth communication component 1842, and/or one or more haptic devices 1846 as described above in reference to peripherals interface 1861. In some embodiments, peripherals interface 1831 includes one or more buttons 1843, a display 1833, a speaker 1844, a microphone 1845, and a camera 1855. In some embodiments, peripherals interface 1831 includes one or more indicators, such as an LED.

It should be appreciated that wearable band computing system 1830 is an example of a computing system within wearable band 1710, and that wearable band 1710 can have more or fewer components than shown in wearable band computing system 1830, combine two or more components, and/or have a different configuration and/or arrangement of the components. The various components shown in wearable band computing system 1830 can be implemented in one or more of a combination of hardware, software, or firmware, including one or more signal processing and/or application-specific integrated circuits.

Wrist-wearable device 1700 with respect to FIG. 17 is an example of wearable band 1710 and watch body 1720 coupled together, so wrist-wearable device 1700 will be understood to include the components shown and described for wearable band computing system 1830 and watch body computing system 1860. In some embodiments, wrist-wearable device 1700 has a split architecture (e.g., a split mechanical architecture, a split electrical architecture, etc.) between watch body 1720 and wearable band 1710. In other words, all of the components shown in wearable band computing system 1830 and watch body computing system 1860 can be housed or otherwise disposed in a combined wrist-wearable device 1700 or within individual components of watch body 1720, wearable band 1710, and/or portions thereof (e.g., a coupling mechanism 1716 of wearable band 1710).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1700 can be used in conjunction with a head-wearable device (e.g., AR glasses 1900 and VR system 2010) and/or an HIPD Error! Reference source not found.00 described below, and wrist-wearable device 1700 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1900 and VR headset 2010.

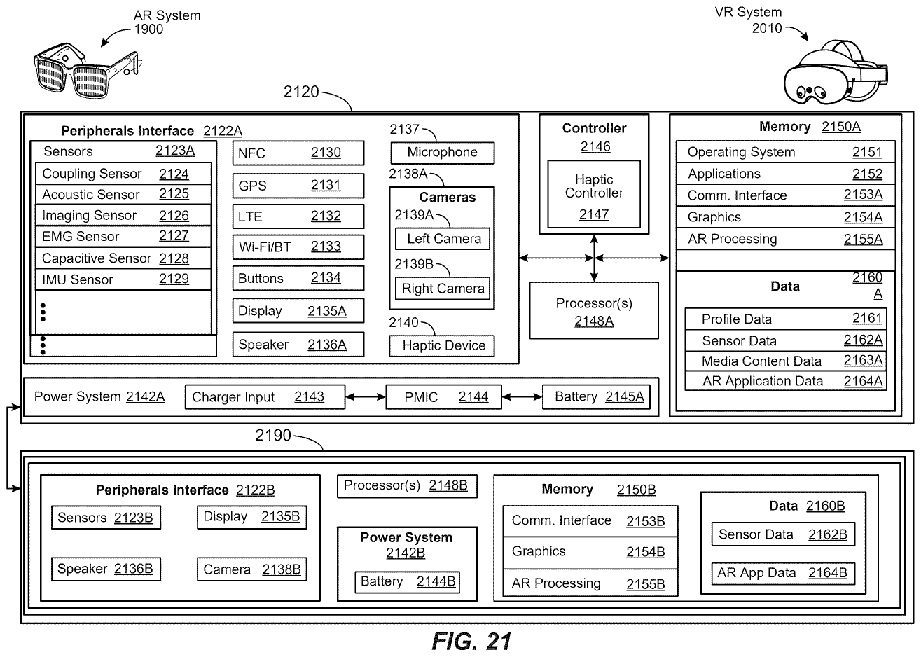

FIGS. 19 to 21 show example artificial-reality systems, which can be used as or in connection with wrist-wearable device 1700. In some embodiments, AR system 1900 includes an eyewear device 1902, as shown in FIG. 19. In some embodiments, VR system 2010 includes a head-mounted display (HMD) 2012, as shown in FIGS. 20A and 20B. In some embodiments, AR system 1900 and VR system 2010 can include one or more analogous components (e.g., components for presenting interactive artificial-reality environments, such as processors, memory, and/or presentation devices, including one or more displays and/or one or more waveguides), some of which are described in more detail with respect to FIG. 21. As described herein, a head-wearable device can include components of eyewear device 1902 and/or head-mounted display 2012. Some embodiments of head-wearable devices do not include any displays, including any of the displays described with respect to AR system 1900 and/or VR system 2010. While the example artificial-reality systems are respectively described herein as AR system 1900 and VR system 2010, either or both of the example AR systems described herein can be configured to present fully-immersive virtual-reality scenes presented in substantially all of a user's field of view or subtler augmented-reality scenes that are presented within a portion, less than all, of the user's field of view.

FIG. 19 show an example visual depiction of AR system 1900, including an eyewear device 1902 (which may also be described herein as augmented-reality glasses, and/or smart glasses). AR system 1900 can include additional electronic components that are not shown in FIG. 19, such as a wearable accessory device and/or an intermediary processing device, in electronic communication or otherwise configured to be used in conjunction with the eyewear device 1902. In some embodiments, the wearable accessory device and/or the intermediary processing device may be configured to couple with eyewear device 1902 via a coupling mechanism in electronic communication with a coupling sensor 2124 (FIG. 21), where coupling sensor 2124 can detect when an electronic device becomes physically or electronically coupled with eyewear device 1902. In some embodiments, eyewear device 1902 can be configured to couple to a housing 2190 (FIG. 21), which may include one or more additional coupling mechanisms configured to couple with additional accessory devices. The components shown in FIG. 19 can be implemented in hardware, software, firmware, or a combination thereof, including one or more signal-processing components and/or application-specific integrated circuits (ASICs).

Eyewear device 1902 includes mechanical glasses components, including a frame 1904 configured to hold one or more lenses (e.g., one or both lenses 1906-1 and 1906-2). One of ordinary skill in the art will appreciate that eyewear device 1902 can include additional mechanical components, such as hinges configured to allow portions of frame 1904 of eyewear device 1902 to be folded and unfolded, a bridge configured to span the gap between lenses 1906-1 and 1906-2 and rest on the user's nose, nose pads configured to rest on the bridge of the nose and provide support for eyewear device 1902, earpieces configured to rest on the user's ears and provide additional support for eyewear device 1902, temple arms configured to extend from the hinges to the earpieces of eyewear device 1902, and the like. One of ordinary skill in the art will further appreciate that some examples of AR system 1900 can include none of the mechanical components described herein. For example, smart contact lenses configured to present artificial reality to users may not include any components of eyewear device 1902.

Eyewear device 1902 includes electronic components, many of which will be described in more detail below with respect to FIG. 21. Some example electronic components are illustrated in FIG. 19, including acoustic sensors 1925-1, 1925-2, 1925-3, 1925-4, 1925-5, and 1925-6, which can be distributed along a substantial portion of the frame 1904 of eyewear device 1902. Eyewear device 1902 also includes a left camera 1939A and a right camera 1939B, which are located on different sides of the frame 1904. Eyewear device 1902 also includes a processor 1948 (or any other suitable type or form of integrated circuit) that is embedded into a portion of the frame 1904.

FIGS. 20A and 20B show a VR system 2010 that includes a head-mounted display (HMD) 2012 (e.g., also referred to herein as an artificial-reality headset, a head-wearable device, a VR headset, etc.), in accordance with some embodiments. As noted, some artificial-reality systems (e.g., AR system 1900) may, instead of blending an artificial reality with actual reality, substantially replace one or more of a user's visual and/or other sensory perceptions of the real world with a virtual experience (e.g., AR systems 1500 and 1600).

HMD 2012 includes a front body 2014 and a frame 2016 (e.g., a strap or band) shaped to fit around a user's head. In some embodiments, front body 2014 and/or frame 2016 include one or more electronic elements for facilitating presentation of and/or interactions with an AR and/or VR system (e.g., displays, IMUs, tracking emitter or detectors). In some embodiments, HMD 2012 includes output audio transducers (e.g., an audio transducer 2018), as shown in FIG. 20B. In some embodiments, one or more components, such as the output audio transducer(s) 2018 and frame 2016, can be configured to attach and detach (e.g., are detachably attachable) to HMD 2012 (e.g., a portion or all of frame 2016, and/or audio transducer 2018), as shown in FIG. 20B. In some embodiments, coupling a detachable component to HMD 2012 causes the detachable component to come into electronic communication with HMD 2012.

FIGS. 20A and 20B also show that VR system 2010 includes one or more cameras, such as left camera 2039A and right camera 2039B, which can be analogous to left and right cameras 1939A and 1939B on frame 1904 of eyewear device 1902. In some embodiments, VR system 2010 includes one or more additional cameras (e.g., cameras 2039C and 2039D), which can be configured to augment image data obtained by left and right cameras 2039A and 2039B by providing more information. For example, camera 2039C can be used to supply color information that is not discerned by cameras 2039A and 2039B. In some embodiments, one or more of cameras 2039A to 2039D can include an optional IR cut filter configured to remove IR light from being received at the respective camera sensors.

FIG. 21 illustrates a computing system 2120 and an optional housing 2190, each of which show components that can be included in AR system 1900 and/or VR system 2010. In some embodiments, more or fewer components can be included in optional housing 2190 depending on practical restraints of the respective AR system being described.

In some embodiments, computing system 2120 can include one or more peripherals interfaces 2122A and/or optional housing 2190 can include one or more peripherals interfaces 2122B. Each of computing system 2120 and optional housing 2190 can also include one or more power systems 2142A and 2142B, one or more controllers 2146 (including one or more haptic controllers 2147), one or more processors 2148A and 2148B (as defined above, including any of the examples provided), and memory 2150A and 2150B, which can all be in electronic communication with each other. For example, the one or more processors 2148A and 2148B can be configured to execute instructions stored in memory 2150A and 2150B, which can cause a controller of one or more of controllers 2146 to cause operations to be performed at one or more peripheral devices connected to peripherals interface 2122A and/or 2122B. In some embodiments, each operation described can be powered by electrical power provided by power system 2142A and/or 2142B.

In some embodiments, peripherals interface 2122A can include one or more devices configured to be part of computing system 2120, some of which have been defined above and/or described with respect to the wrist-wearable devices shown in FIGS. 17 and 18. For example, peripherals interface 2122A can include one or more sensors 2123A. Some example sensors 2123A include one or more coupling sensors 2124, one or more acoustic sensors 2125, one or more imaging sensors 2126, one or more EMG sensors 2127, one or more capacitive sensors 2128, one or more IMU sensors 2129, and/or any other types of sensors explained above or described with respect to any other embodiments discussed herein.

In some embodiments, peripherals interfaces 2122A and 2122B can include one or more additional peripheral devices, including one or more NFC devices 2130, one or more GPS devices 2131, one or more LTE devices 2132, one or more Wi-Fi and/or Bluetooth devices 2133, one or more buttons 2134 (e.g., including buttons that are slidable or otherwise adjustable), one or more displays 2135A and 2135B, one or more speakers 2136A and 2136B, one or more microphones 2137, one or more cameras 2138A and 2138B (e.g., including the left camera 2139A and/or a right camera 2139B), one or more haptic devices 2140, and/or any other types of peripheral devices defined above or described with respect to any other embodiments discussed herein.

AR systems can include a variety of types of visual feedback mechanisms (e.g., presentation devices). For example, display devices in AR system 1900 and/or VR system 2010 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2135A and 2135B can be coupled to each of the lenses 1906-1 and 1906-2 of AR system 1900. Displays 2135A and 2135B may be coupled to each of lenses 1906-1 and 1906-2, which can act together or independently to present an image or series of images to a user. In some embodiments, AR system 1900 includes a single display 2135A or 2135B (e.g., a near-eye display) or more than two displays 2135A and 2135B. In some embodiments, a first set of one or more displays 2135A and 2135B can be used to present an augmented-reality environment, and a second set of one or more display devices 2135A and 2135B can be used to present a virtual-reality environment. In some embodiments, one or more waveguides are used in conjunction with presenting artificial-reality content to the user of AR system 1900 (e.g., as a means of delivering light from one or more displays 2135A and 2135B to the user's eyes). In some embodiments, one or more waveguides are fully or partially integrated into the eyewear device 1902. Additionally, or alternatively to display screens, some artificial-reality systems include one or more projection systems. For example, display devices in AR system 1900 and/or VR system 2010 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2135A and 2135B.

Computing system 2120 and/or optional housing 2190 of AR system 1900 or VR system 2010 can include some or all of the components of a power system 2142A and 2142B. Power systems 2142A and 2142B can include one or more charger inputs 2143, one or more PMICs 2144, and/or one or more batteries 2145A and 2144B.

Memory 2150A and 2150B may include instructions and data, some or all of which may be stored as non-transitory computer-readable storage media within the memories 2150A and 2150B. For example, memory 2150A and 2150B can include one or more operating systems 2151, one or more applications 2152, one or more communication interface applications 2153A and 2153B, one or more graphics applications 2154A and 2154B, one or more AR processing applications 2155A and 2155B, and/or any other types of data defined above or described with respect to any other embodiments discussed herein.

Memory 2150A and 2150B also include data 2160A and 2160B, which can be used in conjunction with one or more of the applications discussed above. Data 2160A and 2160B can include profile data 2161, sensor data 2162A and 2162B, media content data 2163A, AR application data 2164A and 2164B, and/or any other types of data defined above or described with respect to any other embodiments discussed herein.

In some embodiments, controller 2146 of eyewear device 1902 may process information generated by sensors 2123A and/or 2123B on eyewear device 1902 and/or another electronic device within AR system 1900. For example, controller 2146 can process information from acoustic sensors 1925-1 and 1925-2. For each detected sound, controller 2146 can perform a direction of arrival (DOA) estimation to estimate a direction from which the detected sound arrived at eyewear device 1902 of AR system 1900. As one or more of acoustic sensors 2125 (e.g., the acoustic sensors 1925-1, 1925-2) detects sounds, controller 2146 can populate an audio data set with the information (e.g., represented in FIG. 21 as sensor data 2162A and 2162B).

In some embodiments, a physical electronic connector can convey information between eyewear device 1902 and another electronic device and/or between one or more processors 1948, 2148A, 2148B of AR system 1900 or VR system 2010 and controller 2146. The information can be in the form of optical data, electrical data, wireless data, or any other transmittable data form. Moving the processing of information generated by eyewear device 1902 to an intermediary processing device can reduce weight and heat in the eyewear device, making it more comfortable and safer for a user. In some embodiments, an optional wearable accessory device (e.g., an electronic neckband) is coupled to eyewear device 1902 via one or more connectors. The connectors can be wired or wireless connectors and can include electrical and/or non-electrical (e.g., structural) components. In some embodiments, eyewear device 1902 and the wearable accessory device can operate independently without any wired or wireless connection between them.

In some situations, pairing external devices, such as an intermediary processing device (e.g., HIPD 1306, 1406, 1506) with eyewear device 1902 (e.g., as part of AR system 1900) enables eyewear device 1902 to achieve a similar form factor of a pair of glasses while still providing sufficient battery and computation power for expanded capabilities. Some, or all, of the battery power, computational resources, and/or additional features of AR system 1900 can be provided by a paired device or shared between a paired device and eyewear device 1902, thus reducing the weight, heat profile, and form factor of eyewear device 1902 overall while allowing eyewear device 1902 to retain its desired functionality. For example, the wearable accessory device can allow components that would otherwise be included on eyewear device 1902 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1902 standing alone. Because weight carried in the wearable accessory device can be less invasive to a user than weight carried in the eyewear device 1902, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1900 and/or VR system 2010 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 20A and 20B show VR system 2010 having cameras 2039A to 2039D, which can be used to provide depth information for creating a voxel field and a two-dimensional mesh to provide object information to the user to avoid collisions.

In some embodiments, AR system 1900 and/or VR system 2010 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1900 and/or VR system 2010, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some embodiments, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some embodiments, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or, there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some embodiments, acoustic transducers may be connected to artificial reality systems via a wired connection, and in other embodiments acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some embodiments, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
generating, by a first machine-learning model, an intermediate estimate of a target signal within input audio;
computing, based on the estimate and the input audio, parameters of an adaptive filter;
applying the adaptive filter to the input audio to produce a filtered audio signal;
generating, by a second machine-learning model, an enhanced audio signal based at least in part on the filtered signal, wherein the first and second models have been jointly trained end-to-end to enhance the target signal.

2. The method of claim 1, wherein the input audio comprises multichannel audio captured by a microphone array and the adaptive filter comprises a spatial filter.

3. The method of claim 1, further comprising transforming the input audio into a time-frequency representation, wherein computing the parameters of the adaptive filter and generating the intermediate estimate are performed in a time-frequency domain.

4. The method of claim 1, wherein the adaptive filter comprises a multichannel Wiener filter and the parameters are computed online using recursive estimates of cross- and auto-covariance matrices of the input audio and the intermediate estimate.

5. The method of claim 1, wherein the second machine-learning model applies complex spectral masking to jointly refine magnitude and phase of the filtered audio signal to produce the enhanced audio signal.

6. The method of claim 1, wherein the first machine-learning model includes a frequency-dependent spatial processing block comprising per-frequency multiple-input-multiple-output convolutions followed by a recurrent temporal processing block.

7. The method of claim 6, wherein the recurrent temporal processing block comprises split gated recurrent unit layers configured to process feature segments in parallel under causality constraints.

8. The method of claim 1, wherein the first and second machine-learning models are jointly trained end-to-end using a composite objective comprising at least one of target reconstruction loss, phase consistency loss, perceptual quality loss, and artifact suppression loss.

9. A system comprising:
at least one physical processor; and
physical memory comprising computer-executable instructions that, when executed by the at least one physical processor, cause the at least one physical processor to:
generate, by a first machine-learning model, an intermediate estimate of a target signal within input audio;
compute, based on the estimate and the input audio, parameters of an adaptive filter;
apply the adaptive filter to the input audio to produce a filtered audio signal; and
generate, by a second machine-learning model, an enhanced audio signal based at least in part on the filtered signal, wherein the first and second models have been jointly trained end-to-end to enhance the target signal.

10. The system of claim 9, wherein the input audio comprises multichannel audio captured by a microphone array and the adaptive filter comprises a spatial filter.

11. The system of claim 9, wherein the computer-executable instructions further cause the at least physical processor to transform the input audio into a time-frequency representation, wherein the computer-executable instructions cause the at least one physical processor to compute the parameters of the adaptive filter and generate the intermediate estimate in a time-frequency domain.

12. The system of claim 9, wherein the adaptive filter comprises a multichannel Wiener filter and the parameters are computed online using recursive estimates of cross- and auto-covariance matrices of the input audio and the intermediate estimate.

13. The system of claim 9, wherein the second machine-learning model applies complex spectral masking to jointly refine magnitude and phase of the filtered audio signal to produce the enhanced audio signal.

14. The system of claim 9, wherein the first machine-learning model includes a frequency-dependent spatial processing block comprising per-frequency multiple-input-multiple-output convolutions followed by a recurrent temporal processing block.

15. The system of claim 14, wherein the recurrent temporal processing block comprises split gated recurrent unit layers configured to process feature segments in parallel under causality constraints.

16. The system of claim 9, wherein the first and second machine-learning models are jointly trained end-to-end using a composite objective comprising at least one of target reconstruction loss, phase consistency loss, perceptual quality loss, and artifact suppression loss.

17. A non-transitory computer-readable medium comprising computer-executable instructions that, when executed by at least one physical processor of a computing device, cause the computing device to:
generate, by a first machine-learning model, an intermediate estimate of a target signal within input audio;
compute, based on the estimate and the input audio, parameters of an adaptive filter;
apply the adaptive filter to the input audio to produce a filtered audio signal; and
generate, by a second machine-learning model, an enhanced audio signal based at least in part on the filtered signal, wherein the first and second models have been jointly trained end-to-end to enhance the target signal.

18. The non-transitory computer-readable medium of claim 17, wherein the input audio comprises multichannel audio captured by a microphone array and the adaptive filter comprises a spatial filter.

19. The non-transitory computer-readable medium of claim 17, wherein the computer-executable instructions further cause the at least one physical processor to transform the input audio into a time-frequency representation, wherein the computer-executable instructions cause the at least one physical processor to compute the parameters of the adaptive filter and generate the intermediate estimate in a time-frequency domain.

20. The non-transitory computer-readable medium of claim 17, wherein the adaptive filter comprises a multichannel Wiener filter and the parameters are computed online using recursive estimates of cross- and auto-covariance matrices of the input audio and the intermediate estimate.
